(19) United States
(12) Patent Application Publication
(10) Pub. No.: US 2026/0008024 A1
(43) Pub. Date: Jan. 8, 2026

(54) A DEVICE THAT ENABLES THE COMBINATORIAL SYNTHESIS OF SMALL MOLECULE LIBRARIES

(71) Applicant: BRT BIOTECHNOLOGIES, INC., Claremont, CA (US)

(72) Inventors: Gregory Thomas Copeland, Claremont, CA (US); Jane May Liu, Claremont, CA (US)

(21) Appl. No.: 19/102,351

(22) PCT Filed: Nov. 17, 2023
(86) PCT No.: PCT/US2023/080218

§ 371 Date: Feb. 7, 2025

Related U.S. Application Data
(60) Provisional application No. 63/426,600, filed on Nov. 18, 2022.

(51) Int. Cl. B01J 19/00

(52) U.S. Cl. CPC B01J 19/0046; B01J 2219/00596; B01J 2219/0072

(57) ABSTRACT

A device for the synthesis of small molecules on a substrate is provided. The device includes a synthesis plate with vias, and a microfluidic patterning plate with a series ot open-faced channels that can be aligned with the vias on the synthesis plate. The device may be used to synthesize combinatorial libraries of small molecules.

### BACKGROUND OF THE DISCLOSURE

The microfluidic channel-based patterning approach to spatially addressed synthesis, as first described by Southern et al (Matson et al., 1995), allows for the synthesis of large collections of molecules in a relatively compact footprint. In the original publications of Southern et al. (Matson et al., 1995), a few variants were described, including a “crisscross” variant, in which compounds are built up at the intersections of sequentially patterned horizontal and vertical stripes. One unique benefit of the crisscross patterning variant is that a linear increase in the number of stripes can result in an exponential increase in the number of unique compounds generated. The resulting collections of molecules can be screened for function, for example, binding to a known molecule. Other examples of use include oligonucleotide sequencing and immunoassays.

In some protocols crisscross patterning is achieved using microfluidic devices created through soft lithographic techniques, some with features on a sub-micron scale (Bernard et al., 2001; Delamarche et al., 1998; Rowe et al., 1999; Su et al., 2005). There are two patents that apply microfluidic approaches to spatially addressed library syntheses (U.S. Pat. No. 6,508,988B1, Dam et al., 2003; U.S. Pat. No. 5,677,195A, Winkier et al., 1997). However, both patents focus on the synthesis of polymers—peptides and oligonucleotides. Further, both patents describe preferred embodiments in which the microfluidic patterning component has channels, inlets, and outlets all contained within one piece of the system. None of these approaches, however, account for the fact that during small molecule synthesis, the number of unique building blocks available at each step is frequently greater than or equal to the number of channels. Previously proposed pneumatic valve approaches would require an untenable series of sequential reagent additions and flushing steps to deliver hundreds of unique building blocks to hundreds of channels. In addition, for small molecule synthesis, all layers of the device in direct contact with solvents and reagents used during the synthesis must be chemically compatible.

There exists a need for a microfluidic device that enables the synthesis of large and diverse libraries of small organic molecules through spatially addressed synthesis. The present inventors developed microfluidic devices and methods that surmount at least the above-referenced limitations with the devices of the related art. In the present invention, the vias of the microfluidic device, which provide inlets and outlets for the microfluidic channels, are on one piece of the system and the channels are on a separate piece of the system. The separation of the vias from the channels allows for a simplified microfluidic device, which, when prepared with chemically compatible materials, can be applied toward the synthesis of organic small molecules.

### SUMMARY OF THE INVENTION

The disclosure provides a device for the combinatorial synthesis of small molecule libraries on a substrate. The device includes two components: a synthesis plate with vias (through-holes), and a microfluidic patterning plate with a series of open-faced channels that can be aligned with the vias on the synthesis plate such that when the two plates are sandwiched together, fully sealed microfluidic channels are created with one outlet and one inlet for each channel. The separation of the vias and the channels on two separate plates allows for a simplified device that, when prepared with chemically compatible materials, is suitable for synthesis of libraries of organic small molecules.

The side of the synthesis plate that is in contact with the microfluidic patterning plate may be functionalized such that solid phase organic synthesis may be executed on the synthesis plate, the single substrate.

During operation, solvents and solutions are delivered through each channel through either applying pressure (pushing) at the inlets or vacuum (pulling) at the outlets. The synthesis plate and microfluidic patterning plate may be sandwiched in a first orientation and known building blocks are flowed through selected microfluidic channels such that the building blocks covalently bond to the single substrate in an array. The device may then be disassembled, and the synthesis plate and microfluidic patterning plate reassembled into a new sandwich having a second orientation, creating intersections between the first and second series of channels. The flow of known building blocks through selected microfluidic channels in this second orientation will produce synthetic small molecule products at each intersection. The process of disassembly, assembly, and flowing of building blocks may be repeated to achieve multi-step synthetic products at channel intersections. The device may also be used to flow a sequential series of building blocks across channels while maintaining a single orientation to produce synthetic small molecule products within each channel. The device may also be used io flow a sequential series of building blocks across channels while maintaining a single orientation before disassembly and reassembly of the device in a new orientation to produce multi-step synthetic small molecule products at channel intersection.

### BRIEF DESCRIPTION OF DRAWINGS

These and other features, aspects, and advantages of the present subject matter will become better understood when the following detailed description is read with reference to the accompanying drawings, wherein:

FIG. 1A is a schematic top-down view of a synthesis plate (1) that serves as the single substrate for small molecule synthesis. (2) shows the composition of the plate (3) shows arrays of vias. (4) shows reference marks.

FIG. 1B is a schematic cutaway side view of a synthesis plate that serves as the single substrate for small molecule synthesis. (2) shows the composition of the plate. (5) shows a series of vias.

FIG. 2A is a schematic top-down view of the microfluidic patterning plate (6) used to create microfluidic channels. (7) shows the composition of the plate. (8) shows microfluidic inlet and outlet depressions. (9) shows microfluidic channels. (10) shows reference marks.

FIG. 2B is a schematic cutaway side view of the microfluidic patterning plate used to create microfluidic channels. (7) shows the composition of the plate. (11) shows a layer of elastomeric material. (12) shows a series of channels.

FIG. 3A is a schematic top-down view of the top plate (13) of the mechanical clamping system. (14) shows the composition of the plate. (15) shows holes drilled through the plate. (16) shows a cutaway region in the center of the plate.

FIG. 3B is a schematic bottom-up view of the top plate (13) of the mechanical clamping system. (14) shows the composition of the plate. (15) shows holes drilled through the plate. (16) shows a cutaway region in the center of the plate. (17) shows an O-ring bordering the cutaway.

FIG. 4A is a schematic top-down view of the bottom plate (18) of the mechanical clamping system. (19) shows the composition of the plate. (20) shows holes drilled through the plate. (21) shows an O-ring recessed into the plate. (22) shows a fluid fitting threaded into a hole in the plate. (23) shows a hole drilled through the top part of the plate.

FIG. 4B is a schematic bottom-up view of the bottom plate (18) of the mechanical clamping system. (19) shows the composition of the plate. (20) shows holes drilled through the plate. (22) shows a fluid fitting threaded into a hole in the plate.

FIG. 5 is a schematic cutaway side view of an overall embodiment of the device with a mechanical clamp surrounding the sandwiched synthesis plate and microfluidic patterning plate. (13) and (18) show the top plate and bottom plate, respectively, of the mechanical clamping system. (1) shows the synthesis plate, which is also referred to as the single substrate. (7) shows the composition of the microfluidic patterning plate, on top of which is a thin layer of elastomeric material (11) on which microfluidic channels have been patterned (12). (17) and (21) show O-rings that are recessed into the top and bottom plates, respectively. (24) shows screws used to combine the system. (22) shows a threaded fluid fitting that delivers pressurized fluid or gas into the cavity (25).

FIG. 6 is generated by fluorescence imaging of a synthesis plate on which small molecules were synthesized using the device. The attached molecules were probed with dye-conjugated protein and the plate was imaged. Fluorescence corresponding to protein-bound molecules are observed as white or grey spots. Black borders represent areas where no dye-conjugated protein is bound.

FIG. 7A is an LC analysis of the multi-step synthesis of a JQ1-VHL ligand conjugate using the invention. LC traces of each crude intermediate (structures provided) are shown.

FIG. 7B is an LC/MS analysis of the final product, the structure of which is shown, of the multi-step synthesis of a JQ1-VHL ligand conjugate using the invention. The inset shows the MS data for the major peak in the LC trace.

FIG. 8 is an LC/MS analysis of the final product, the structure of which is shown, of a multistep synthesis using the invention. This represents a first example JQ1-CRBN ligand conjugate (#1) that was synthesized. The inset shows the MS data for the major peak in the LC trace.

FIG. 9 is an LC/MS analysis of the final product, the structure of which is shown, of a multistep synthesis using the invention. This represents a second example JQ1-CRBN ligand conjugate (#2) that was synthesized. The inset shows the MS data for the major peak in the LC trace.

FIG. 10 is the LC/MS analysis of Product 1, synthesized using the invention by adding Boc-L-leucine hydrate to a trifunctional core structure (L-lysine) coupled to a linker and a chromophore. The left panel shows the LC trace and structure of the product. The right panel shows the MS data for the major peak in the LC trace.

FIG. 11 is the LC/MS analysis of Product 2, synthesized using the invention by adding Boc-L-phenylalanine to a trifunctional core structure (L-lysine) coupled to a linker and a chromophore. The left panel shows the LC trace and structure of the product. The right panel shows the MS data for the major peak in the LC trace.

FIG. 12 is the LC/MS analysis of Product 3, synthesized using the invention by adding Boc-α-aminoisobutyric acid to a trifunctional core structure (L-lysine) coupled to a linker and a chromophore. The left panel shows the LC trace and structure of the product. The right panel shows the MS data for the major peak in the LC trace.

FIG. 13 is the LC/MS analysis of Product 4, synthesized using the invention by adding Z-L-alanine to a trifunctional core structure (L-lysine) coupled to a linker and a chromophore. The left panel shows the LC trace and structure of the product. The right panel shows the MS data for the major peak in the LC trace.

FIG. 14 is the LC/MS analysis of Product 5, synthesized using the invention by adding 4-nitrobenzoic acid to a trifunctional core structure (L-lysine) coupled to a linker and a chromophore. The left panel shows the LC trace and structure of the product. The right panel shows the MS data for the major peak in the LC trace.

FIG. 15 is the LC/MS analysis of Product 6, synthesized using the invention by adding hydrocinnarnic acid to a trifunctional core structure (L-lysine) coupled to a linker and a chromophore. The left panel shows the LC trace and structure of the product. The right panel shows the MS data for the major peak in the LC trace.

FIG. 16 is the LC/MS analysis of Product 7, synthesized using the invention by adding 4-methoxyphenylacetic acid to a trifunctional core structure (L-lysine) coupled to a linker and a chromophore. The left panel shows the LC trace and structure of the product. The right panel shows the MS data for the major peak in the LC trace.

FIG. 17 is the LC/MS analysis of Product 8, synthesized using the invention by adding phenylacetic acid to a trifunctional core structure (L-lysine) coupled to a linker and a chromophore. The left panel shows the LC trace and structure of the product. The right panel shows the MS data for the major peak in the LC trace.

FIG. 18 is the LC/MS analysis of Product 9, synthesized using the invention by adding 2-furoic acid to a trifunctional core structure (L-lysine) coupled to a linker and a chromophore. The left panel shows the LC trace and structure of the product. The right panel shows the MS data for the major peak in the LC trace.

FIG. 19 is the LC/MS analysis of Product 10, synthesized using the invention by adding butyric acid to a trifunctional core structure (L-lysine) coupled to a linker and a chromophore. The left panel shows the LC trace and structure of the product. The right panel shows the MS data for the major peak in the LC trace.

FIG. 20 is the LC/MS analysis of Product 11, synthesized using the invention by adding glutaric anhydride to a trifunctional core structure (L-lysine) coupled to a linker and a chromophore. The left panel shows the LC trace and structure of the product. The right panel shows the MS data for the major peak in the LC trace.

FIG. 21 is the LC/MS analysis of Product 12, synthesized using the invention by adding 5-nitro-2-furoic acid to a trifunctional core structure (L-lysine) coupled to a linker and a chromophore. The left panel shows the LC trace and structure of the product. The right panel shows the MS data for the major peak in the LC trace.

### DETAILED DESCRIPTION OF THE DISCLOSURE

Unless defined otherwise, all technical and scientific terms used herein have the same meaning as is commonly understood by one of ordinary skills in the art to which this disclosure belongs.

Except where noted otherwise, capitalized and non-capitalized forms of all terms fall within each meaning.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless otherwise indicated, it is understood that all numbers expressing quantities, ratios, and numerical properties of ingredients, reaction conditions, and so forth used in the specification and claims are contemplated to be able to be modified in all instances by the term “about” or “approximately”. As used herein, the term “about” when used before a numerical designation, e.g., temperature, time, amount, concentration, and such other, including a range, indicates approximations which may vary by (+) or (−) 10%, 5%, of 1%.

Unless otherwise indicated, drawings with indicated dimensions provide an embodiment for the practice of the disclosure. It is to be understood that dimensions may be altered or the location of the relative placement of functional components may be altered without affecting the overall function or usability in other embodiments.

The present and preferred embodiment of the disclosure is a device and a method for the combinatorial synthesis of small molecule libraries on a single substrate. The device includes a synthesis plate having a plurality of vias that are arrayed in a pattern The synthesis plate is also referred to as the single substrate for library synthesis. The device also includes a microfluidic patterning plate having a series of open-faced channels that can be aligned with some or all the vias on the synthesis plate such that, when the two plates are sandwiched together, a plurality of fully sealed microfluidic channels are created with one outlet and one inlet for each channel. The synthesis plate, the microfluidic patterning plate, or both plates may have reference marks. The separation of the vias and the channels on two separate plates allows for a simplified device that, when prepared with chemically compatible materials, is suitable for synthesis of libraries of organic small molecules.

The synthesis plate may involve a series of vias that are spaced to correspond to the inlets and outlets of the microfluidic channels in the final assembled device. The synthesis plate has two sides, which may also be referred to as faces. One of these faces will come into contact with the microfluidic patterning plate. The vias go through the entire plate. This synthesis plate may be of a material such as glass, silicon, polyethylene, polypropylene, aluminum, or any planarized material the surface of which can be covalently, chemically modified and upon which small molecule libraries are synthesized. The plate may be of any dimensions that support the desired synthesis of small molecules (see below). In a preferred embodiment, the plate is made of approximately 3 mm thick borosilicate glass, with dimensions between 100×100 mm² to 300×300 mm². The plate does not need to be a square.

The face of the synthesis plate that is in contact with the microfluidic patterning plate is coated with a functionality that enables solid phase synthesis to be executed on that single substrate. This functionalization may serve as starting points for solid supported chemistry. These functional groups may be covalently or noncovalently linked to the plate; continuous or discontinuous on the plate; spotted or patterned on the plate. Patterns may involve micro-sized, two-dimensional features (including lines and shapes) that are regularly or irregularly spaced across the plate. Examples of patterns include single lines, sets of lines, ovals and circles, rectangles and squares. Multiple features may be patterned on the same plate. Patterning may be achieved through photopatterning, printing, through the use of the microfluidics at the beginning of library syntheses, or in combination.

Functional groups may include amines, aminosilanes, carboxyl groups, hydroxyl groups, or any functionality that has previously been reported to effectively undergo chemical reactions in solid phase organic syntheses. Initial attachment of these functional groups to the synthesis plate will be dependent on the plate composition. For glass substrates, functionalization may be performed using well established liquid phase or gas phase silanization protocols (Cras et al., 1999; Munief et al., 2018). For polymeric substrates, functionalization may be achieved through a plasma-based activation process, and/or plasma-based deposition of functional groups (Demirci et al., 2014; Inagaki et al., 1992). Certain polymeric substrates, such as poly (methyl methacrylate) display ester functionality on their surfaces that can serve as reactive functional groups (Fixe et al., 2004). Polytetrafluoroethylene (PTFE) related substrates may be functionalized through chemical etching, plasma treatments, and/or ion beam treatments (Kim, 2000). Alternatively, to increase the amount of compound synthesized at each reaction site, the synthesis plate may be covalently coated with a dendrimer or polymer containing functional groups, such that effective functional group density is higher than would be expected from a purely two-dimensional functionalization (Benters et al., 2002). The polymer or dendrimer may coat the entire plate surface or may be patterned only in regions where library synthesis is to occur. Patterning may be achieved through photopatterning, printing, using the microfluidics at the beginning of library syntheses, or in combination.

Vias are holes that may be created by drilling through a plate. Depending on the composition of the synthesis plate, the vias may be formed though any mechanism that creates through-holes, such as mechanical drilling, powder blasting, and/or laser etching. The vias may be as small as about 0.01 mm in diameter and as large as about 10 mm in diameter. The preferred range is between about 0.05-5 mm in diameter. Via diameter may also vary on the same plate. In certain embodiments, vias that are to be used exclusively as inlets may have diameters larger or smaller than vias used exclusively as outlets, for example. Via shape may also vary. In certain embodiments, vias may have a constant diameter through the plate, while in other embodiments, the vias may have a tapered geometry. The tapered geometry may facilitate sealing with pipet tips used to aspirate or dispense reagents. The vias correspond to the inlets and outlets of the final assembled device. Depending on the situation, vias used as inlets in one step of the synthesis may be used as outlets in a subsequent step, and vice versa. Depending on the selected microfluidic patterning plate that is being used at a given step during synthesis, only a subset of the vias may be used. In addition, a single synthesis plate may be patterned with vias to allow for libraries of differing sizes. For example, a synthesis plate may have multiple vias that are never used in a given synthesis.

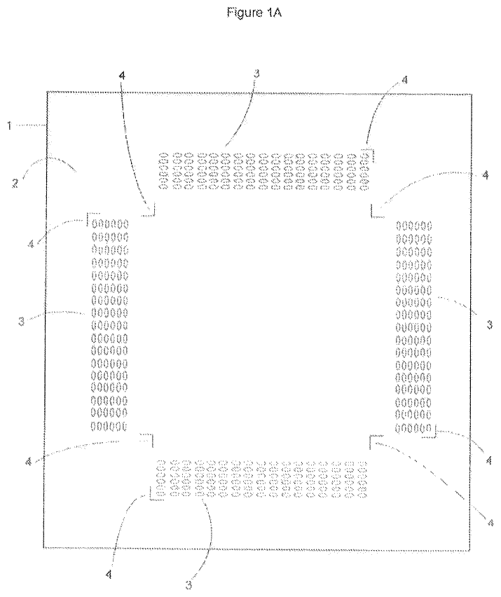

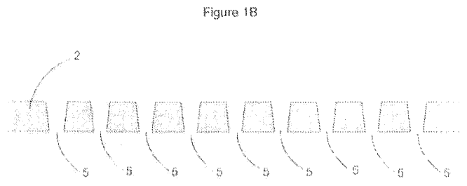

The vias on the synthesis plate may be patterned as rectangular arrays with center to center spacing as close as about 0.10 mm and up to about 18 mm. Via patterns may also be irregular. Although many patterns of vias may be used in the device, in a preferred embodiment, the vias are patterned in four sets of rectangular arrays with each set on one side of the synthesis plate, as shown in FIG. 1A. In a preferred embodiment, the via spacing is directly matched to the spacing of SBS-formatted well plates, which facilitates the use of plates and multichannel pipettes that are widely available. Center to center spacing between vias of about 9 mm corresponds to the spacing of a 96 well plate, spacing of about 4.5 mm corresponds to spacing of a 384 well plate, and spacing of about 2.25 mm corresponds to the spacing of a 1536 well plate (e.g., Sigma Aldrich part #CLS3891, Corning 1536 well plates). The center to center spacing between vias may be the same in both the X and Y dimensions, or they may differ. In the example provided in FIG. 1A, the spacing is about 4.5 mm in one direction and about 2.25 mm in another.

The number of vias may be as low as two, one corresponding to an inlet and the other an outlet, and up to 100,000 total vias, up to half of which may be used as inlets and the other half may be used as outlets during a single synthetic step. A preferred embodiment would have a range of 16-4,096 total vias in a single synthesis plate.

The microfluidic patterning plate has two sides, which may also be referred to as faces. One of these faces will come into contact with the synthesis plate to create fully sealed microfluidic channels. The microfluidic patterning plate may be produced through soft lithographic processes, including creation of a photomask delineating the channel pattern (Qin et al., 2010). The photomask is then used to create a photoresist-based “master”, which is a negative shape of the desired microfluidic pattern on a glass or silicon plate. Following application of a mold release agent to the master, the actual microfluidic patterning plate is created by sandwiching a pre-polymer solution between the master and a flat sheet of material that has good X-Y dimensional stability, but flexibility perpendicular to its thin dimension. The pre-polymer and polymer solution used may be SIFEL (a fluoroelastomer from Shin-Etsu), Sylgard 184 or similar silicone, or Fluorolink. The flat sheet could be a 100-400 μm thick sheet of tempered glass, aluminum, steel, or a chemically compatible polymer. This flat sheet may be of any dimensions that allow for sandwiching with the synthesis plate. In a preferred embodiment, the flat sheet is between 100×100 mm² to 300×300 mm². The flat sheet does not need to be a square. This flat sheet may be chemically modified to bond to the final polymeric pattern. The chemical modification depends on the pre-polymer or polymer used. In the case of a platinum-cured silicone or SIFEL, the surface may be covalently coated with a vinyl silane. In the case of an acrylate or acrylamide pre-polymer, the surface may be coated with a thiol-silane or an acrylate-derived silane. Following curing and separation of the sandwich, the polymeric microfluidic pattern remains attached to the flat sheet and allows for reuse of the master in creating multiple copies of the microfluidic patterning plate.

In another embodiment, the microfluidic patterning plate may be made through a hot embossing technique using thermoplastic elastomers such as Dyneon, Kalrez, or Viton (Trimbach et al., 2003).

Microfluidic channels or channels are features that allow for the transport of fluid, including water, solvents, solutions, reagents, and building blocks. Open-faced channels are channels in which at least one face of the channel is open to the environment.

To align channels with vias means to overlay at least part of a channel with both one via that can serve as an inlet and another via that can serve as an outlet.

Reference marks, which may also be denoted as alignment marks or registration marks, refer to micro-sized, two-dimensional features (including lines and shapes) that may be used for visually aligning and overlaying two separate plates that make up the device. Examples of such reference marks include single lines, sets of lines (in perpendicular or parallel orientation), ovals and circles, rectangles and squares. Alternatively, reference marks may be raised features (including lines and shapes) on one plate and depressed features (including lines and shapes) on a second plate that, upon alignment, the reference marks fit together in a complementary manner.

Sandwiched means the overlay of at least two device layers to create an ensemble consisting of at least two layers.

The number of fully sealed microfluidic channels created when sandwiching a synthesis plate and a microfluidic patterning plate depends on the number of vias on the synthesis plate and the number of open-faced channels on the microfluidic patterning plate. Each fully sealed microfluidic channel requires two vias, one to serve as an inlet, and the other to serve as an outlet. In some embodiments, multiple channels may each have their own inlet via, but share a common outlet via. In other embodiments, multiple channels may share a common inlet via, but each channel would have its own outlet via. A large variety of microfluidic patterning plates of arbitrary channel patterns may be used with any synthesis plate, so long as the parts of the channels meant to serve as entry and exit points for fluid flow are spaced to match vias on the synthesis plate.

The number of vias does not need to match the number of channels. There may be vias on the synthesis plate that do not align with any channels on the microfluidic patterning plate. There may be channels on the microfluidic patterning plate that do not align with any vias on the synthesis plate. In some embodiments, the same microfluidic patterning plate may be used to create different channel patterns when sandwiched with different synthesis plates based on how the two plates align and which channels are aligned with which vias. With a minimum of two vias that align with one open-faced channel, one fully sealed microfluidic channel may be created. With a maximum of 100,000 total vias that align with 50,000 open-faced channels, 50,000 fully sealed microfluidic channels may be created. A preferred embodiment of 16 vias on a single synthesis plate could be used to create 1-8 fully sealed microfluidic channels, depending on the patterning of the vias and the number of available open-faced channels. Another preferred embodiment of 4,096 total vias on a single synthesis plate could be used to create 1-2,048 fully sealed microfluidic channels, depending on the patterning of the vias and the number of available open-faced channels.

An example of a synthesis plate (1), the single substrate, is shown in FIG. 1A. Vias may be drilled into an approximately 3 mm thick borosilicate glass plate (2) in arrays (3). In this example, the vias are about 2.25 mm center-to-center down a column of six vias and about 4.5 mm center-to-center across a row of seventeen vias. Four arrays of 102 vias are on this example synthesis plate, creating a total of 408 vias. Reference marks (4) may be included to enable alignment with the microfluidic patterning plate (6).

An example cross-sectional view of the example synthesis plate, the single substrate, is shown in FIG. 1B. A series of vias of the synthesis plate (1) is shown where the vias are drilled into the approximately 3 mm thick borosilicate glass plate (2). Representative vias (5) are shown. The vias are about 0.9 mm wide at the top of the plate and about 0.6 mm wide at the bottom of the plate, and approximately 4.5 mm center-to-center.

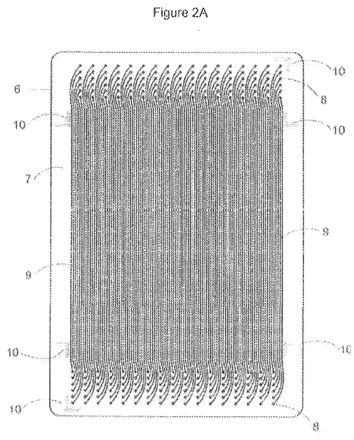

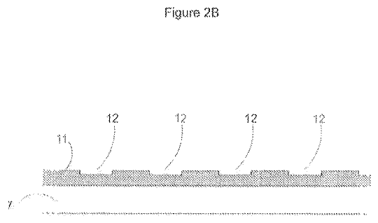

An example of a microfluidic patterning plate (6) is shown in FIG. 2A, having approximately 200-300 μm sheet of tempered glass (7), where the features, including microfluidic inlet and outlet depressions (8), microfluidic channels (9), and reference marks (10), may be recessed into an approximately 150 μm thin layer of elastomeric material through standard soft lithography techniques using a microfluidics master. In this example, there are 102 channels, each with one inlet depression and one outlet depression.

An example cross-sectional view of the microfluidic patterning plate (6) is shown in FIG. 2B. An approximately 150 μm thin layer of elastomeric material (11) rests on an approximately 200-300 μm sheet of tempered glass (7). Representative channels (12) are shown, each about 350 μm wide and about 50 μm tall, with about 400 μm spacing between channels. Other configurations are possible and encompassed within the invention.

A preferred embodiment of the device includes a mechanical clamping system that when applied to the sandwiched synthesis plate and microfluidic patterning plate creates a uniform clamping force across the back side of the microfluidic pattern plate (U.S. Pat. No. 5,677,195A, Winkler et al., 1997). The clamping system may involve hydraulics or pneumatics to apply clamping pressure. This clamping is not necessary for creating a sandwiched synthesis plate and microfluidic patterning plate.

Hydraulic means the use of pressurized liquid, including water and solvents, such as mineral oil, silicone oil, hydraulic fluid, in a confined space. In the case of fluids that conduct heat or cool, the temperature of the synthetic reactions may then be precisely controlled to be between about −25 to 200° C. In a preferred embodiment, water would be used for temperature control between about 4 to 100° C.

Pneumatic means the use of pressurized gasses, including air and nitrogen, in a confined space.

Clamping means the exertion of a reproducible and uniform pressure.

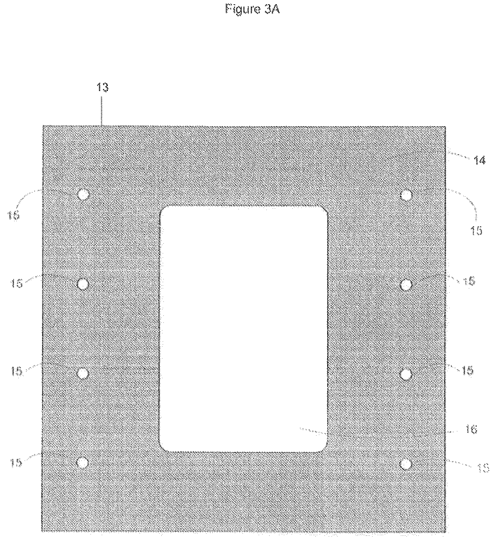

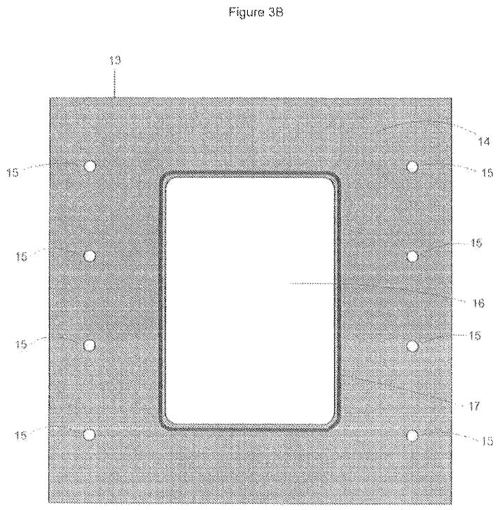

An example view of the topside of the top plate (13) of the mechanical clamping system is shown in FIG. 3A, which consists of a sheet of 7075 aluminum that is about 205 mm×205 mm and about 6.35 mm thick (14). Holes (15), about 5.8 mm in diameter, may be drilled through the plate. The centers of these holes may be about 20 mm from the left and right edges of the plate. Each hole is about 45 mm center-to-center with neighboring holes. In the center of the plate, a region about 125 mm×86 mm is cutaway (16).

An example view of the bottom-side of the top plate (13) of the mechanical clamping system is shown in FIG. 3B, having a sheet of 7075 aluminum that is about 205 mm×205 mm and about 6.35 mm thick (14). Holes (15), about 5.8 mm in diameter, may be drilled through the plate. The centers of these holes may be about 20 mm from the left and right edges of the plate. Each hole is about 45 mm center-to-center with neighboring holes. In the center of the plate, a region about 125 mm×86 mm region is cutaway (16). Bordering this cutaway may be an approximately 3.5 mm O-ring made of silicone or soft Viton (17) (e.g., McMaster Carr cat. #1173N488). The O-ring may be separated from the center cutaway by about 1 mm and recessed into the plate by approximately 2 mm.

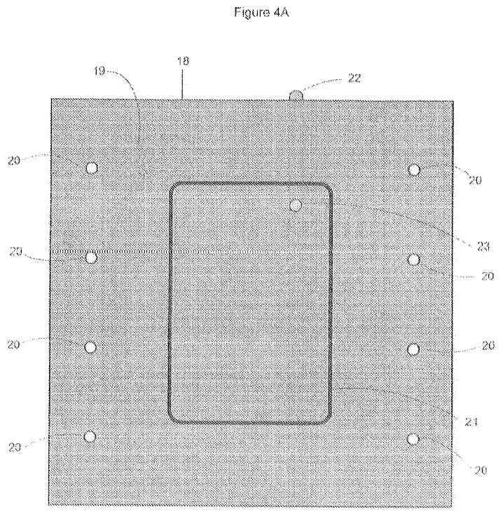

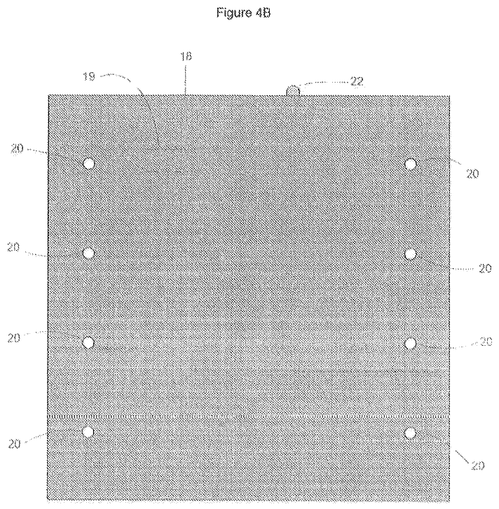

An example view of the topside of the bottom plate (18) of the mechanical clamping system is shown in FIG. 4A, having a sheet of 7075 aluminum that is about 205 mm×205 mm sheet and about 12.7 mm thick (19). Holes (20), each about 0.159 inch in diameter, may be drilled through the plate and threaded with a 10-32 tap. The centers of these holes are about 20 mm from the left and right edges of the plate. Each hole may be about 45 mm center-to-center with neighboring holes. In the center of the plate, an O-ring made of silicone or soft Viton (21) (e.g., McMaster Carr cat. #1173N488) may border a region that is approximately, at its widest regions, 121 mm tall and 82 mm wide. The O-ring is recessed into the plate by about 2 mm. On one edge of the plate a 1/16 NPT-threaded fluid fitting (22) (e.g., McMaster Carr cat. #7880T112) is threaded into an approximately 53 mm-long hole in the plate. Such a fitting allows for the delivery of pressurized water, another fluid, air, or another gas into the space bordered by the O-ring through an approximately 6 mm hole drilled about 5.5 mm through the top part of the plate (23).

An example view of the bottom-side of the bottom plate (18) of the mechanical clamping system is shown in FIG. 4B, having a sheet of 7075 aluminum that is about 205 mm×205 mm sheet and about 12.7 mm thick (19). Holes (20), each about 0.159 inch in diameter, may be drilled through the plate and threaded with a 10-32 tap. The centers of these holes are about 20 mm from the left and right edges of the plate. Each hole may be about 45 mm center-to-center with neighboring holes. On one edge of the plate a 1/16 NPT-threaded fluid fitting (22) (e.g., McMaster Carr cat. #7880T112) is threaded into an approximately 53 mm-long hole in the plate.

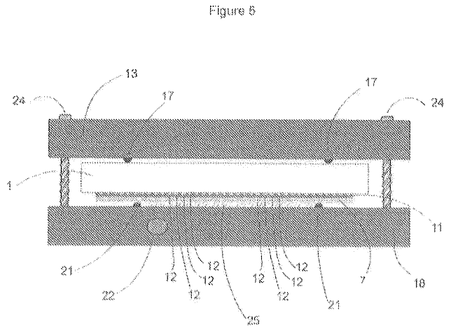

In FIG. 5, an example cross-sectional view of an overall embodiment of the device is shown. A mechanical clamping system, involving two aluminum sheets (13 and 18), surrounds the synthesis plate (1) and microfluidic patterning plate, having of a sheet of tempered glass (7) on top of which is a thin layer of elastomeric material (11) on which microfluidic channels have been patterned (12), which are sandwiched together. For clarity, only some of the channels have been labeled. O-rings (17 and 21), about 3.5 mm in diameter, made of silicone or soft Viton (e.g., McMaster Carr cat. #1173N488), are recessed into the aluminum sheets. 316 stainless steel flanged button head screws (24) (e.g., McMaster Carr cat #90909A525) are used to stably combine the aluminum sheets and the sandwich. A 1/16 NPT-threaded fluid fitting (22) delivers pressurized fluid or gas into the cavity (25) to allow for pressurized clamping of the device and possible temperature control during reaction synthesis.

### Combinatorial Synthesis

Embodiments of the device may be applied to the synthesis of as few as 1 and up to 625,000,000 total small molecules on a single substrate, also referred to as the synthesis plate, using building blocks with reactive groups, some of which may be appropriately protected by a protecting group. A preferred embodiment would synthesize libraries of 100-10,000,000 small molecules on a single substrate, each covalently attached to the substrate via a linker.

Combinatorial chemistry refers to methods of synthesizing final compounds through the stepwise, sequential addition of building blocks to intermediates or partially synthesized intermediate compounds (U.S. Pat. No. 6,045,755A, Lebl et al., 1997). Through the systematic and simultaneous variation of multiple chemical building blocks or reaction conditions, a diverse array of chemical compounds may be generated. In a preferred embodiment, during a multistep synthesis, in at least one of the synthesis steps or a series of reactions, multiple unique compounds are generated. These steps are referred to as diversity-generating steps. In a preferred embodiment, a linear increase in the number of reactions results in an exponential increase in the number of compounds generated. For example, the invention may be used for a one step parallel synthesis that could result in 100 different molecules synthesized; after rotation of the device (see below), a second step of parallel synthesis would result in 10,000 different molecules.

The method of combinatorial chemistry described in this invention involves multiple steps, wherein each step involves the flow of a known reagent or substance through at least one channel of the assembled device such that the reagent or substance comes into contact with the region of the substrate delineated by the walls of the selected channel. The flow of a known reagent or substance through any channel could be for generating diversity through the addition of a building block. The flow of a known reagent or substance through any channel could also be for the removal of a protecting group, converting one chemical group to another, or preparing the chemical groups on the region of the substrate delineated within the channel walls for the next step. The flow of a known reagent or substance involves adding enough volume of said reagent or substance to fill the selected channel. Once the channel is filled, one skilled in the art will know for how long the reagent or substance needs to sit in the channel in order for the desired chemistry to take place. In some chemistries, the desired chemical reaction may be instantaneous. In other chemistries, the desired chemistry may require the reagent or substance to sit in the channel for up to two hours.

Example reactive groups may include acetylenes, acyl halides, alcohols, aldehydes, alkenes, alkyl halides, primary amines, secondary amines, amides, amidines, aryl halides, azides, boronic acids, boronic esters, carboxylic acids, carboxylic esters, dienes, dienophiles, epoxides, halocarbamates, halocarbonates, halooximes, hydrazides, hydrazones, hydroxylamines, isocyanates, isothiocyanates, ketones, nitriles, oximes, sulfonamides, sulfonyl halides, thiols, and alpha-beta unsaturated carbonyl groups. This list is meant to be representative.

Embodiments of the device allow the representative reactive groups listed above to be used for solid phase organic synthesis reactions that include amide bond formation, reductive amination, nucleophilic substitution of aromatic and aliphatic halides, Suzuki coupling, Ullman coupling, benzimidazole synthesis, van-Leusen reaction, pyrazolidinone synthesis, Larock indole synthesis, N-9-fluorenylmethoxycarbonyl (Fmoc) deprotection, N-tert-butyloxycarbonyl (Boc) deprotection, t-butyl ester deprotection, trityl deprotection, t-butyl ether deprotection, ester hydrolytic deprotection, halocarbonate coupling to amines and alcohols, halocarbamate coupling to amines and alcohols, isocyanate reactions with amines, isothiocyanate reactions with amines, Ugi reaction, activated carbonate coupling to amines and alcohols, sulfonyl halide coupling to amines and alcohols, Mitsunobu reaction between carboxylic acids and alcohols, Mitsunobu reaction between phenols and alcohols, Mitsunobu reaction between sulfonamides and alcohols, palladium mediated deprotection of allyl-derived protecting groups, deprotection of benzyl protecting groups, azide-alkyne cycloaddition, Diels-Alder reaction, ruthenium mediated metathesis reaction, transamidation of esters, oxidation of primary and secondary alcohols, reduction of aldehydes and ketones, and reduction of nitro groups. It would be expected that most chemistry previously applied to resin based or surface supported solid phase chemistry should be compatible with the device (Kates & Albericio, 2019). In addition, it is expected that all chemistry previously demonstrated to work in the context of DNA encoded library synthesis will also be compatible with the device (Fair et al., 2021; Fitzgerald & Paegel, 2021; Malone & Paegel, 2016; Satz et al., 2022). The minimal requirements for a reaction being compatible with the device include that the reaction solution needs to be able to fill the channel, and the reaction solution needs to be compatible with the glass, metal, or polymer materials that come into direct contact with the reaction solution only over the course of the reaction. The microfluidic device can work with heterogeneous reactions, so long as the reaction slurry can fill the channel. In contrast to many other microfluidic devices used in multistep syntheses, a reaction may form a precipitate or cease to be capable of flowing through a channel, without adversely impacting that particular reaction. This is because at the end of any steps in a synthesis that yields precipitate or plugged channels, the microfluidic patterning plate may be simply separated from the synthesis plate, any plugged inlets and outlets on the synthesis plate may be cleared, and the microfluidic patterning plate may either be replaced or cleaned prior to the next reaction step.

Example building blocks include any molecule containing one or more of the reactive groups listed above. In some cases, building blocks may contain one or more reactive groups and one or more latent or masked reactive groups. Such combinations include: amine-aryl halides, Fmoc amino acids, aldehyde-aryl halides, amine-azides, aldehyde-carboxylic acids, carboxylic acid-esters, carboxylic acid-aryl halides, Boc amino acids, amine-acids, amine-esters, biotin, carboxylic acid-isothiocyanates, N-Boc amine-aldehydes, aldehyde-sulfonyl halides, mono-N-Boc-protected bisamines, azide-sulfonyl halides, ester-isocyanates, ester-sulfonyl halides, carboxylic acid-alkynes, carboxylic acid nitro groups, aldehyde esters, aldehyde-nitro groups, aldehyde-azides, azide-aryl halides, carboxylic acid-azides, aryl halide-alkynes, aryl halide-aryl halides.

Protecting groups are used when a chemical reaction is performed on a multifunctional compound and only a subset of functional groups on that multifunctional compound are intended to react. Protecting groups may also be used when performing a chemical reaction on an array of surface-bound molecules, providing spatial and temporal control over where and when functional groups on a surface may react.

It is expected that all types of protecting groups used in solid-phase organic synthesis are also compatible with the device (Wuts & Greene, 2007). Examples of protecting groups include Fmoc, Boc, trityl, allyl, N-Allyloxycarbonyl (Alloc), nitrobenzenesulfonyl (Nos), 1-(4,4-dimethyl-2,6-dioxocyclohexylidene)ethyl (Dde), 1-(4,4-dimethyl-2,6-dioxocyclohex-1-ylidene)-3-methylbutyl (ivDde), 2-phenylisopropyl group (2-PhiPr), 2-(2-Nitrophenyl) propoxycarbonyl (NPPOC), benzyloxycarbonyl (Cbz), 4-(N-[1-(4,4-dimethyl-2,6-dioxocyclo-hexylidene)-3-methylbutyl]amino)benzyl (Dmab), methoxytrityl, methyl esters, 6-nitroveratryloxycarbonyl (Nvoc), trimethylsilyl (TMS), triisopropylsilyl (TIPS), t-butyldimethylsilyl (TBS), trifluoracetyl, p-toluenesulfonyl (Tos), tetrahydropyranyl (THP), triethylsilyl (TES), 9-fluorenylmethyl (Fm), 2,2,4,6,7-pentamethyldihydrobenzofuran-5-sulfony (PBF). As azido groups and nitro groups can be reduced to primary amines, azido groups and nitro groups can also serve as protecting groups, functionally behaving like primary amino protecting groups.

Examples of linkers used to provide covalent immobilization of the molecule as it is being synthesized on the synthesis plate may include ester linkages, for example the 4-(Hydroxymethyl)phenoxyacetic acid (HMPA) linker, 4-(Hydroxymethyl)benzoic acid (HMBA) linker, succinate linker, or trityl linker. Alternatively, amide linkages could be used, for example, an alkyl amide linker, the Rink Amide linker (Bernatowicz et al., 1989; Rink, 1987), the Peptide amide linker (PAL) (Yraola et al., 2004), the Backbone Amide Linker (BAL linker, CAS 115109-59-6), aryl hydrazide linker (Woo et al., 2007),or the photocleavable amide linker (PC linker: Fmoc-Photo-Linker, CAS 162827-98-7). Trityl linkers and their methyl, chloro, and methoxy substituted derivatives may be used to immobilize molecules through carboxyl, hydroxyl, amino, and thiol functionalities. Other linkers that may be used include the Kenner safety catch linker and the modified variant of it described in (Backes & Ellman, 1999). This list is meant to be representative (Guillier et al., 2000; Eggenweiler, 1998).

The number of synthetic products representing a diversity of arrayed small molecules will be determined by the user and will depend on the desired application. The device may be used to produce a single small molecule product. With up to 100,000 vias, the device may be used to produce 625,000,000 different synthetic small molecule products on the substrate. Preferred embodiments would have diverse libraries consisting of 100-10,000,000 different synthetic small molecule products arrayed on the single substrate.

With each assembled microfluidics device, one skilled in the art will select the number of channels and the number of different building blocks flown through those channels to determine the diversity of that synthetic step. One skilled in the art will select the number of times the process of disassembly and reassembly is repeated, as well as the number of orientations used, to determine the size and complexity of the final library of small molecules.

With the synthesis plate and microfluidic patterning plate sandwiched in a first orientation, selected known building blocks are added to the inlets of selected microfluidic channels. Here and below, when the synthesis plate and microfluidic patterning plate are sandwiched in an orientation, fully sealed microfluidic channels are created with one outlet and one inlet for each channel. Each channel only receives one building block for each synthetic step. Here and below, the same or different building blocks may be added to different channels. One skilled in the art will select the building blocks for each channel to accomplish the desired chemistry. The addition of a building block to an inlet may involve placing a pipet in fluid communication with an inlet via for a selected microfluidic channel and injecting the selected building block through the via such that the building block enters the microfluidic channel and flows to the outlet via. This approach of using a pipet to deliver liquid through a channel can also be used anywhere in the method that requires addition of a solvent, solution, reagent, of building block. Alternatively, a syringe may be used to deliver liquids whenever the addition of a solvent, solution, reagent, or building block is required. The process of adding a selected building block to a selected channel may be repeated for additional building blocks and additional channels. Different channels may be filled sequentially or in parallel, for example, by using a multichannel pipet. This approach can also be used anywhere in the method that requires the addition of selected building block(s) to selected channel(s).

Flow of the building blocks across the channels allows for the building blocks to bind covalently to the region of the synthesis plate, which acts as the single substrate for organic synthesis, delineated by the walls of the selected channels. The flow of 2 or more different building blocks, each in its own channel, will result in a diversity of building blocks that are arrayed on the single substrate. After the flow of building blocks, wash solutions may be flowed through the channels to remove any unreacted building blocks, side-products, or contaminants that may interfere with further reactions. This step can also be used anywhere in the method that requires the removal of any unreacted reagents, side-products, or contaminants. Wash solutions may also prepare the substrate for any subsequent chemistry, for example by changing the charge state of surface bound functional groups, or by removing residual matter that may interfere with subsequent chemistry. This residual matter may be solid, liquid, or gaseous in nature. Protecting groups may then be removed using protecting group removal reagents that may be flowed through the microfluidic channels in which building blocks with protecting groups were added. This step can also be used anywhere in the method that requires the removal of protecting groups to allow for subsequent reactivity.

Flow refers to the movement of solvents and solutions through each channel by either applying pressure (pushing) at inlets or outlets, applying vacuum at the inlets or outlets, altering relative heights of inlets to outlets such that gravitational forces drive fluid movement, or by applying a centrifugal force parallel to the desired direction of flow. Flow may also be driven through capillary action, or through the application of an electrical field to induce electrophoretic flow or electroosmotic flow. Flow may also be induced through a combination of the above-described methods.

Wash solutions may be a solvent, a mixture of solvents, a solvent with one or more dissolved solutes, or a mixture of solvents with one or more dissolved solutes. A wash solution is often the solvent used in the immediately preceding or subsequent reaction step. Examples of wash solutions include dimethyl sulfoxide (DMSO); dimethyl formamide (DMF); water; methanol; acetonitrile (ACN); aqueous sodium bicarbonate solutions; aqueous ethylenediaminetetraacetic acid (EDTA) solutions; sodium diethyldithiocarbamate solutions; N-methylpyrrolidinone (NMP); methylene chloride (DCM): 0.1%-5% triethylamine in DMF, NMP, DCM, acetonitrile, or THF. A series of wash solutions may be applied to directly displace previously applied reagents. Alternatively, a stream of nitrogen gas, or air, may also be used to purge a channel of solvents or reagents between sequential additions of reagents or wash solutions. Wash solutions may be applied and allowed to sit for some period of time at some specified temperature if desired.

Examples of protecting group removal reagents include: 5-50% piperidine or 4-methylpiperidine in DMF, DMSO, or NMP with 0-10% of a weak acid such as formic acid or hydroxybenzotriazole added to attenuate the overall basicity of the solution; 1-5% 1,8-diazabicyclo(5.4.0)undec-7-ene (DBU) with 1-10% piperidine in DMF, DMSO, or NMP; 1-50% trifluoroacetic acid in methylene chloride, THE, acetonitrile, dioxane, or ethyl acetate; 1-6% hydrazine in acetonitrile, DMF, NMP, or THF; 0.01-5 molar aqueous hydroxide solutions; 0.01-5 molar aqueous hydrochloric acid solutions; 0.01-5 molar hydrochloric acid in, THF, dioxane, methanol, or ethyl acetate; aqueous phosphoric acid; sulfuric acid in DCM, THE, dioxane, methanol, or ethyl acetate; iron (III) chloride in DCM; tetrakis(triphenylphosphine)palladium(0) and phenyl silane in DMF, DCM, or methanol; tetrakis(triphenylphosphine)palladium(0) and borane-dimethylamine in DMF, DCM, or methanol; aqueous dithiothreitol solutions; 0.1-30% solutions of ammonia in water, methanol, dioxane, or THF; tris(2-carboxyethyl)phosphine solutions; and basic sodium borate solutions. Protecting group removal reagents may be applied once or multiple times. Deprotections may be run at a variety of temperatures.

Reactions, deprotections, and washes may all be applied to the synthesis plate using a microfluidic patterning plate. Alternatively, if all synthesis sites on a given plate are to be exposed to identical conditions at a given step in a library build, the surface of the synthesis plate may be exposed in bulk to those conditions in a bath.

In one embodiment, after the flow of building blocks, the sandwiched synthesis plate and microfluidic patterning plate are then dissembled, and the microfluidic patterning plate may be rotated relative to the synthesis plate. Reassembling the sandwich in this second orientation creates a plurality of fully sealed microfluidic channels that are non-parallel to the first series of channels created in the first orientation. Here and below, every time that the device is disassembled and then reassembled, a new series of microfluidic channels is created. The channels from the first and the second orientations create intersections. Small molecule products may be synthesized at these intersections. In this second orientation, selected known building blocks are added to the inlets of selected microfluidic channels. Here and below, the building blocks may be the same as or different from the building blocks added when the microfluidics device was in its prior orientation. One skilled in the art will select the building blocks for each channel to accomplish the desired chemistry. Different channels may be filled sequentially or in parallel, for example, by using a multichannel pipet. The building blocks are flowed across the channels allowing covalent coupling between the building blocks at each intersection that received a building block through the first series of channels and a building block through the second series of channels. The flow of building blocks, each in its own channel, will result in synthetic small molecule products arrayed on the single substrate. When different building blocks are used in ≥2 channels when the device is in the first orientation, the second orientation, or both, a diversity of different small molecule products will be arrayed on the single substrate.

Parallel refers to the X-Y translation of a plate, where the plate is moved left or right, up or down, but not rotated in any way. Non-parallel means any orientation that is not an X-Y translation of the microfluidic patterning plate. The second orientation of the microfluidic patterning plate would result from the rotation of the microfluidic patterning plate around the Z axis.

In some embodiments, the disassembly and reassembly of the sandwich of the synthesis plate and microfluidic patterning plate may be repeated once such that in between disassembly and reassembly, the microfluidic patterning plate is rotated back into the first orientation. After reassembly, building blocks are flown across the newly formed channels, as above, and covalent couplings occur at intersections between the new series of channels and the immediately prior series of channels to achieve a diversity of synthetic small molecule products resulting from the covalent coupling of three building blocks.

In some embodiments, this process of disassembly and reassembly is repeated such that the microfluidic patterning plate oscillates between the first and second orientation at least twice to achieve a diversity of synthetic small molecule products resulting from multi-step syntheses. Oscillates means goes back and forth.

In some embodiments, after the flow of the second building block, between disassembly and reassembly, the microfluidic patterning plate is rotated into a third orientation that is non-parallel to both the first and second orientation. After reassembly, building blocks are flown across the newly formed channels, as above, and covalent couplings occur at intersections between the new series of channels and the immediately prior series of channels to achieve a diversity of synthetic small molecule products resulting from the covalent coupling of three building blocks.

In some embodiments, this process of disassembly and reassembly is repeated such that the microfluidic patterning plate oscillates between multiple orientations (≥3) at least once to achieve a diversity of synthetic small molecule products resulting from multi-step syntheses. For example, a multi-step synthesis could involve the device in a first, then second, then third, then first, then second, then third orientation, involving the covalent coupling of six building blocks. As another example, a multi-step synthesis could involve the device in a first, then second, then third, then first orientation, involving the covalent coupling of four building blocks. These examples are meant to be representative.

In some embodiments, after disassembly of the sandwich of the synthesis plate and microfluidic patterning plate, a different, new microfluidic patterning plate is sandwiched to the synthesis plate to create a plurality of fully sealed microfluidic channels. This new microfluidic patterning plate is a separate plate from the one used in the prior synthesis step. This new microfluidic patterning plate may have the same channel pattern and reference marks as the prior microfluidic patterning plate, or it may differ in channel patterns or reference marks, or both. The use of a new plate may be beneficial when the desired channel pattern for the new sandwich differs from the prior sandwich. The use of a new plate may also be beneficial when insoluble precipitates form in at least one of the channels during a synthetic step. Rather than cleaning the device, the application of a new microfluidic patterning plate to create the subsequent sandwich may be desirable. In addition, if desired chemical reagents are used that have limited compatibility with the microfluidic patterning plate, the plate only needs to maintain channel integrity through the duration of one synthetic step. The subsequent step or steps would then use a new microfluidic patterning plate. In some embodiments, this new microfluidic patterning plate would be sandwiched in a new orientation in which a new series of channels that are non-parallel to the prior series of channels are created, forming intersections between the immediately prior and the new series of channels, with one outlet and one inlet for each channel. In another embodiment, this new microfluidic patterning plate would be sandwiched in the same orientation as the microfluidic patterning plate it is replacing, creating a new series of channels that are exactly parallel to the prior series of channels. In any case, building blocks are then flown across the newly formed channels and covalent couplings occur between the new series of channels and the immediately prior series of channels to achieve a diversity of synthetic small molecule products resulting from the covalent coupling of building blocks.

In some embodiments, with the synthesis plate and microfluidic patterning plate sandwiched in a first orientation, a first set of selected known building blocks are flowed through selected microfluidic channels allowing the building blocks to bind covalently to the substrate contained within each of the selected channels. Each channel only receives one building block for each synthetic step. Here and below, the same or different building blocks may be added to different channels. One skilled in the art will select the building blocks for each channel to accomplish the desired chemistry. Wash solutions may then be flowed through the channels. Protecting group removal may be performed. With the microfluidic patterning plate still in the first orientation, a second set of selected known building blocks may be flowed through the same selected microfluidics channels that received the first building blocks, allowing covalent couplings to occur within the selected channels between the building blocks of set one and set two. The building blocks in set one and two may be the same, they may be entirely different, or they may share some commonality. After addition of the second set of building blocks, wash solutions may be flowed and protecting group removal may be performed. In some embodiments, additional flow of sets of building blocks may be performed to achieve a diversity of synthetic small molecule products, each containing ≥3 building blocks, arrayed on the single substrate.

In some embodiments, with the synthesis plate and microfluidic patterning plate sandwiched in a first orientation, after the flow of ≥2 building blocks across each selected channel, the sandwich may be disassembled, and the microfluidic patterning plate may be rotated relative to the synthesis plate. Reassembling the sandwich in this second orientation creates microfluidic channels that are non-parallel to the first series of channels created in the first orientation. The channels from the first and the second orientations create intersections. Covalent couplings may occur at these intersections by flowing through the newly formed series of channels a new set of building blocks. The covalent couplings will occur at intersections between the new series of channels and the immediately prior series of channels until a diversity of synthetic small molecules resulting from a multi-step synthesis are arrayed on the substrate. In some embodiments, multiple (≥2) sets of building blocks may be sequentially flowed in this second orientation, allowing additional covalent couplings to occur. In some embodiments, the process of disassembly and reassembly is repeated such that the microfluidic patterning plate oscillates between different orientations to achieve a diversity of synthetic small molecule products resulting from multi-step syntheses. In some embodiments, between disassembly and reassembly, the microfluidic patterning plate is rotated into a third orientation that is non-parallel to both the first and second orientation The channels from the first, second, and third orientations create intersections. Covalent couplings may occur at these intersections by flowing through the newly formed series of channels a new set of building blocks. In some embodiments, multiple (≥2) sets of building blocks may be sequentially flowed in this third orientation, allowing additional covalent couplings to occur. In some embodiments, this process of disassembly and reassembly is repeated such that the microfluidic patterning plate oscillates between multiple orientations (>2) at least once to achieve a diversity of synthetic small molecule products resulting from multi-step syntheses. In some embodiments, after disassembly of the sandwich of the synthesis plate and microfluidic patterning plate, a different, new microfluidic patterning plate is sandwiched to the synthesis plate to create a plurality of fully sealed microfluidic in a new orientation in which this new series of channels is non-parallel to the prior series of channels, creating intersections between the prior and new series of channels, with one outlet and one inlet for each channel. The use of a new plate may be beneficial when the desired channel pattern for the new sandwich differs from the prior sandwich. The use of a new plate may also be beneficial when insoluble precipitates form in at least one of the channels during a synthetic step. In addition, if desired chemical reagents are used that have limited compatibility with the microfluidic patterning plate, the plate only needs to maintain channel integrity through the duration of one synthetic step.

Advantages of the disclosure include a simplified microfluidics device and methods that provide the ability to achieve exponential increases in the number of small molecules synthesized through only linear increases in reaction steps. Merely as an example, using a device permitting 102 parallel reactions using a microfluidic patterning plate with 102 channels, 10,404 intersections can be obtained, each a unique reaction site, while requiring only 204 individual reagent additions. Furthermore, when using validated building blocks and reaction chemistry, the identity of each synthesized molecule is known based on its spatial location. No barcodes or additional tags are needed to identify molecules when synthesized libraries are used in potential downstream screening of selection applications.

An additional advantage of the disclosure is a simplified microfluidics device in which the synthesis plate with vias is separate from the microfluidic patterning plate with open-faced channels. This type of microfluidics device has not been previously described in the context of crisscross patterning. By placing the inlets and outlets on the substrate, the soft lithography used to create the channels in the final device can be accomplished in just one step. In addition, the device may be made of glass and organic solvent-compatible fluoroelastomers to deliver building blocks to a glass substrate that is suitable for organic solid-phase synthesis. As the microfluidic component is a single layer element, the soft elastomeric material that defines the microfluidic pattern can be directly patterned onto a substrate with high lateral rigidity. The high lateral rigidity eliminates shrinkage-induced changes to the dimensions of the microfluidic pattern during formation of the pattern and facilitates alignment of the microfluidic pattern over relatively large surface areas when applying the microfluidic patterning plate to the synthesis plate.

Additional embodiments of the invention include the following.

The invention provides a device for the combinatorial synthesis of small molecule libraries on a single substrate, said device comprised of:
a) a synthesis plate with a plurality of vias (through-holes), in which the vias are patterned in arrays and the total number of vias on the plate will be between 2-100,000, and
b) a microfluidic patterning plate, with a series of open-faced channels that are aligned with some or all the vias on the synthesis plate such that, when the two plates are sandwiched together, a plurality of fully sealed microfluidic channels are created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality that enables solid phase synthesis to be executed on the substrate.
   In one embodiment, the plate is coated covalently. In another embodiment, the plate is coated noncovalently. Merely by way of example, the plate may be coated continuously or discontinuously. Merely by way of another example, the plate may be coated using spots, micro-sized, two-dimensional shapes. Examples of shapes include, but are not limited to, ovals and circles, rectangles and squares. Alternatively, the plate maybe coated using a pattern. Examples of patterns include, but are not limited to, single lines, sets of lines, ovals and circles, rectangles and squares that are regularly or irregularly spaced across the plate.

In accordance with the practice of the invention, in the device of the invention, a mechanical clamping system may be applied to create a uniform clamping force across the back side of the microfluidic patterning plate. said system comprised of:
a) a pressurized fluid used to apply clamping pressure, where the fluid may be water or some other fluid that conducts heat or cools such that the temperature of the reactions may be precisely controlled; or
b) a pressurized gas used to apply clamping pressure, where the gas may be air or some other gas.

The invention further provides a device that enables the combinatorial synthesis of small molecule libraries on a single substrate, said device comprised of:
a) a synthesis plate with a plurality of vias (through-holes), in which the vias are patterned in four sets of rectangular arrays as shown in FIG. 1A and the total number of vias on the plate will be between about 16-4096; and
b) a microfluidic patterning plate as shown in FIGS. 2A and 2B, with a series of open-faced channels of between about 1-1024 that are aligned with some or all the vias on the synthesis plate such that, when the two plates are sandwiched together, at least one fully sealed microfluidic channel is created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality selected from any of aminopropylsilane, lightly cross-linked, partially functionalized dimethylacrylamide, PEG or PAMAM dendrimers that enables solid phase synthesis to be executed on that substrate.

In another embodiment of the invention, the invention provides a device that enables the combinatorial synthesis of small molecule libraries on a single substrate, said device comprised of:
a) a synthesis plate with a plurality of vias (through-holes), in which the vias are patterned in four seis of rectangular arrays as shown in FIG. 1A and the total number of vias on the plate will be between about 96-1024; and
b) a microfluidic patterning plate as shown in FIGS. 2A and 2B, with a series of open-faced channels of between about 1-256 that are aligned with some or all the vias on the synthesis plate such that, when the two plates are sandwiched together, at least one fully sealed microfluidic channel is created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality selected from any of aminopropylsilane, lightly cross-linked, partially functionalized dimethylacrylamide, PEG or PAMAM dendrimers that enables solid phase synthesis to be executed on that substrate.

In a further embodiment of the invention, the device comprises:
a) a synthesis plate with a plurality of vias (through-holes), in which the vias are patterned in four sets of rectangular arrays as shown in FIG. 1A and the total number of vias on the plate will be between about 96-384; and
b) a microfluidic patterning plate as shown in FIGS. 2A and 2B, with a series of open-faced channels of between about 1-96 that are aligned with some or all the vias on the synthesis plate such that, when the two plates are sandwiched together, at least one fully sealed microfluidic channel is created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality selected from any of aminopropylsilane, lightly cross-linked, partially functionalized dimethylacrylamide, PEG or PAMAM dendrimers that enables solid phase synthesis to be executed on that substrate.

In a further embodiment, the device comprises:
a) a synthesis plate with a plurality of vias (through-holes), in which the vias are patterned in four sets of rectangular arrays as shown in FIG. 1A and the total number of vias on the plate will be about 384-1536; and
b) a microfluidic patterning plate as shown in FIGS. 2A and 2B, with a series of open-faced channels of between about 1-384 that are aligned with some or all the vias on the synthesis plate such that, when the two plates are sandwiched together, at least one fully sealed microfluidic channel is created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality selected from any of aminopropylsilane, lightly cross-linked, partially functionalized dimethylacrylamide, PEG or PAMAM dendrimers that enables solid phase synthesis to be executed on that substrate.

Further, the invention provides a device that enables the combinatorial synthesis of small molecule libraries on a single substrate, said device comprised of:
a) a synthesis plate with a plurality of vias (through-holes), in which the vias are patterned in four sets of rectangular arrays as shown in FIG. 1A and the total number of vias on the plate will be between about 1024-2048; and
b) a microfluidic patterning plate as shown in FIGS. 2A and 2B, with a series of open-faced channels of between about 1-512 that are aligned with some or all the vias on the synthesis plate such that, when the two plates are sandwiched together, at least one fully sealed microfluidic channel is created with one outlet and one inlet for each channel;
c) wherein the synthesis plate and the microfluidic patterning plate are separate; and
d) optionally, wherein the synthesis plate has a face that is in contact with the microfluidic patterning plate and is coated with a functionality selected from any of aminopropylsilane, lightly cross-linked, partially functionalized dimethylacrylamide, PEG or PAMAM dendrimers that enables solid phase synthesis to be executed on that substrate.

The invention additionally provides a device that enables the combinatorial synthesis of small molecule libraries on a single substrate, said device comprised of:
a) a synthesis plate with a plurality of vias (through-holes), in which the vias are patterned in four sets of rectangular arrays as shown in FIG. 1A and the total number of vias on the plate will be about 400 as shown in FIG. 1A (3); and
b) a microfluidic patterning plate as shown in FIGS. 2A and 2B, with a series of open-faced channels of about 100 as shown in FIG. 2A (12) that are aligned with some or all the vias on the synthesis plate such that, when the two plates are sandwiched together, a plurality of fully sealed microfluidic channels are created with one outlet and one inlet for each channel;
c) wherein the synthesis plate and the microfluidic patterning plate are separate; and
d) optionally, wherein the synthesis plate has a face that is in contact with the microfluidic patterning plate is coated with a functionality selected from any of aminopropylsilane, lightly cross-linked, partially functionalized dimethylacrylamide, PEG or PAMAM dendrimers that enables solid phase synthesis to be executed on that substrate.

The invention further provides a method for combinatorial synthesis of small molecule libraries on a single substrate using a device of the invention with a plurality of microfluidic channels, said method using building blocks with reactive groups and comprising the steps of:
a) with the synthesis plate and microfluidic patterning plate sandwiched in a first orientation, flowing a selected known building block through a first selected microfluidic channel and binding covalently said selected building block to the substrate delineated by the walls of the selected channel; and
b) flowing a known building block through a different selected microfluidic channel and binding covalently said building block to the substrate delineated by the walls of the selected channel; and
c) repeating step b) wherein selected building blocks are flowed through other selected microfluidic channels and bound covalently to other delineated regions of the synthesis plate until a diversity of building blocks are arrayed on the single substrate; and
d) flowing wash solutions through selected microfluidic channels; and
e) disassembling the sandwich, rotating the microfluidic patterning plate relative to the synthesis plate, and reassembling the sandwich so as to create a plurality of new fully sealed microfluidic channels in a second orientation in which this second series of channels are non-parallel to the first series of channels used in steps a)-d), creating intersections between the first and second series of channels, with one outlet and one inlet for each channel; and
f) repeating steps a)-d) once such that covalent coupling between building blocks occurs at each intersection that receives a building block through the first orientation of channels and a building block through the second orientation of channels, until a diversity of synthetic small molecule products is arrayed on the single substrate.

Examples of building blocks include, but are not limited to, any of amine-aryl halides, N-fluorenylmethoxycarbonyl (Fmoc) amino acids, aldehyde-aryl halides, amine-azides, aldehyde-carboxylic acids, carboxylic acid-esters, carboxylic acid-aryl halides, N-tert-butyloxycarbonyl (Boc) amino acids, amine-acids, amine-esters, biotin, carboxylic acid-isothiocyanates, N-Boc amine-aldehydes, aldehyde-sulfonyl halides, mono-N-Boc-protected bisamines, azide-sulfonyl halides, ester-isocyanates, ester-sulfonyl halides, carboxylic acid-alkynes, carboxylic acid-nitro groups, aldehyde-esters, aldehyde-nitro groups, aldehyde-azides, azide-aryl halides, carboxylic acid-azides, aryl halide-alkynes, or aryl halide-aryl halides.

In one embodiment, in the method of the invention, each step of flowing selected small molecule building blocks through said microfluidic channels comprises: placing a pipet or syringe in fluid communication with the inlet vias for said microfluidic channels; and injecting said selected building block through said vias so as the building blocks enter the microfluidic channels and flow to the outlet vias.

For example, in a method of the invention, the building blocks with reactive groups, some of which are appropriately protected by a protecting group, the method provides that in step d), following wash solutions, protecting group removal reagents are flowed through selected microfluidic channels.

In an embodiment of the methods of the invention, only one building block is flowed through a single selected channel in the first orientation and the second orientation, such that a single small molecule product is synthesized on the single substrate.

In another embodiment of the methods of the invention, building blocks are flowed through only one selected channel in the first orientation and two selected channels in the second orientation, such that two small molecule products are synthesized on the single substrate.

In an additional embodiment of the methods of the invention, building blocks are flowed through two selected channels in the first orientation and only one selected channel in the second orientation, such that two small molecule products are synthesized on the single substrate.

In a further embodiment of the methods of the invention, building blocks are flowed through two selected channels in the first orientation and two selected channels in the second orientation, such that four small molecule products are synthesized on the single substrate.

In accordance with the practice of the invention, the sandwich is disassembled and then reassembled at least twice, oscillating between a first and second orientation, and in each instance, building blocks are flown through the new channels and covalent couplings occur at intersections between the new series of channels and the immediately prior series of channels, until a diversity of synthetic small molecule products resulting from multi-step synthesis is achieved.

In one embodiment, after covalent coupling occurs with the device in its second orientation, the sandwich is disassembled, and the sandwich is reassembled so as to create a plurality of new fully sealed microfluidic channels in a third orientation in which this third series of channels are non-parallel to both the first and second series of channels used in steps a)-d), creating intersections between the first, second, and third series of channels, with one outlet and one inlet for each channel; and repeating steps a)-d) once such that covalent coupling between building blocks occurs at each intersection that receives a building block through the first three orientation of channels, until a diversity of synthetic small molecule products resulting from multi-step synthesis is achieved. Throughout this process, removal of protecting groups after synthetic steps is performed as needed.

In accordance with the practice of the invention, the sandwich may be disassembled and then reassembled at least three times, oscillating between ≥3 orientations, and in each instance, building blocks are flown through the new channels and covalent couplings occur at intersections between the new series of channels and the immediately prior series of channels, until a diversity of synthetic small molecule products resulting from multi-step synthesis is achieved.

In some embodiments, following any disassembly of the sandwich, a different, new microfluidic patterning plate is sandwiched to the synthesis plate to create a plurality of fully sealed microfluidic channels, with one outlet and one inlet for each channel.

The invention further provides a method for combinatorial synthesis of small molecule libraries on a single substrate using a device of the invention with a plurality of microfluidic channels, said method using building blocks with reactive groups and comprising the steps of:
a) with the synthesis plate and microfluidic patterning plate sandwiched in a first orientation, flowing a selected known building block through a first selected microfluidic channel and binding covalently said selected building block to the substrate delineated by the walls of the selected channel; and
b) flowing a known building block through a different selected microfluidic channel and binding covalently said building block to the substrate delineated by the walls of the selected channel; and
c) repeating step b) wherein selected building blocks are flowed through other selected microfluidic channels and bound covalently to other delineated regions of the substrate plate until a diversity of building blocks are arrayed on the single substrate; and
d) flowing wash solutions through selected microfluidic channels; and
e) flowing a selected known building block through each of the selected microfluidic channels used in steps a)-d) such that covalent coupling between building blocks occurs within this first selected series of channels; and
f) flowing wash solutions through selected microfluidic channels; and
g) disassembling the sandwich, rotating the microfluidic patterning plate relative to the synthesis plate, and reassembling the sandwich to create a plurality of new fully sealed microfluidic channels in a second orientation in which this second series of channels are non-parallel to the first series of channels used in steps a)-f), creating intersections between the first and second series of channels, with one outlet and one inlet for each channel; and
h) repeating steps a)-d) once such that covalent coupling between molecules occurs at each intersection that received building blocks occurs at each intersection that received a building block through the first orientation of channels and a building block through the second orientation of channels, until a diversity of synthetic small molecule products is arrayed on the single substrate.

Merely by way of example, the building blocks may be amine-aryl halides, N-fluorenylmethoxycarbonyl (Fmoc) amino acids, aldehyde-aryl halides, amine-azides, aldehyde-carboxylic acids, carboxylic acid-esters, carboxylic acid-aryl halides, N-tert-butyloxycarbonyl (Boc) amino acids, amine-acids, amine-esters, biotin, biotin, carboxylic acid-isothiocyanates, N-Boc amine-aldehydes, aldehyde-sulfonyl halides, amine-N-Boc amines, azide-sulfonyl halides, ester-isocyanates, ester-sulfonyl halides, carboxylic acid-alkynes, carboxylic acid-nitro groups, aldehyde-esters, aldehyde-nitro groups, aldehyde-azides, azide-aryl halides, carboxylic acid-azides, aryl halide-alkynes, or aryl halide-aryl halides.

In some embodiments, each step of flowing selected small molecule building blocks through said microfluidic channels comprises: placing a pipet or syringe in fluid communication with the inlet vias for said microfluidic channels; and injecting said selected building block through said vias so as the building blocks enter the microfluidic channels and flow to the outlet vias.

In some embodiments, the building blocks with reactive groups, some of which are appropriately protected by a protecting group, requiring that in steps d) and f), following wash solutions, protecting group removal reagents are flowed through selected microfluidic channels.

In some embodiments, the steps of the method stops after step f) such that a diversity of synthetic small molecule products has been arrayed across the single substrate.

In some embodiments, building blocks are flowed through a single selected channel in the first orientation and the second orientation, such that a single small molecule product is synthesized on the single substrate.

In some embodiments, building blocks are flowed through only one selected channel in the first orientation and two selected channels in the second orientation, such that two small molecule products are synthesized on the single substrate.

In some embodiments, building blocks are flowed through two selected channels in the first orientation and only one selected channel in the second orientation, such that two small molecule products are synthesized on the single substrate.

In some embodiments, building blocks are flowed through two selected channels in the first orientation and two selected channels in the second orientation, such that four small molecule products are synthesized on the single substrate.

In some embodiments, with the microfluidic device in its first orientation, more than two separate sets of building blocks are sequentially flown through the first series of channels, until a diversity of synthetic small molecules resulting from a multi-step synthesis are arrayed on the single substrate.

In some embodiments, following any disassembly and reassembly of the sandwich, two or more separate sets of building blocks are sequentially flown through the newly formed series of channels, until a diversity of synthetic small molecules resulting from a multi-step synthesis are arrayed on the single substrate.

In some embodiments, the sandwich is disassembled and then reassembled at least twice, oscillating between a first and second orientation, and in each instance, building blocks are flown through the new channels and covalent couplings occur at intersections between the new series of channels and the immediately prior series of channels, until a diversity of synthetic small molecule products resulting from multi-step synthesis is achieved.

In some embodiments, after covalent couplings occur with the device in its second orientation, the sandwich is disassembled, and the sandwich is reassembled so as to create a plurality of new fully sealed microfluidic channels in a third orientation in which this third series of channels are non-parallel to both the first and second series of channels used in steps a)-f), creating intersections between the first, second, and third series of channels, with one outlet and one inlet for each channel; and repeating steps a)-d) once such that covalent coupling between building blocks occurs at each intersection that receives a building block through the first three orientation of channels, until a diversity of synthetic small molecule products resulting from multi-step synthesis is achieved. Throughout this process, removal of protecting groups after synthetic steps is performed as needed.

In some embodiments, following any disassembly and reassembly of the sandwich, two or more separate sets of building blocks are sequentially flown through the newly formed series of channels, until a diversity of synthetic small molecules resulting from a multi-step synthesis are arrayed on the single substrate.

In some embodiments, the sandwich is disassembled and then reassembled at least three times, oscillating between ≥3 orientations, and in each instance, building blocks are flown through the new channels and covalent couplings occur at intersections between the new series of channels and the immediately prior series of channels, until a diversity of synthetic small molecule products resulting from multi-step synthesis is achieved.

In some embodiments, following any disassembly of the sandwich, a different, new microfluidic patterning plate is sandwiched to the synthesis plate to create a plurality of fully sealed microfluidic channels, with one outlet and one inlet for each channel.

The following examples are presented to illustrate the present disclosure and to assist one of ordinary skills in making and using the same. The examples are not intended in any way to otherwise limit the scope of the disclosure.

### EXAMPLES

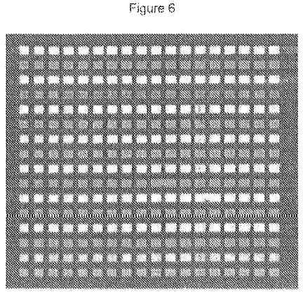

MULTIPLE DEVICE ORIENTATION (CRISSCROSS) PROCESS: FIG. 6 shows the results of a synthesis using the invention, from which we can conclude that the invention allows for synthetic reactions—in this case, amide couplings—to take place in an array of 102×102 synthesis spots as expected (350×350 μm², with 750 μm center-to-center spacing). In this example, activated biotin formed covalent bonds with free amines on the substrate. Subsequently, the covalently attached biotin was probed with dye-conjugated streptavidin and the substrate was then imaged. Fluorescence corresponding to biotin-bound streptavidin is observed in the 350×350 μm² synthesis spots. Black borders represent areas where the streptavidin was unable to bind due to lack of any covalently bound biotin. These 400 μm spacers between synthesis spots that are largely free of signal qualitatively demonstrate the uniformity of the synthesis. These data confirm that the invention can be used to achieve crisscross patterning and spatially addressed synthesis.

All methods described herein can be performed in any suitable order unless otherwise indicated herein or otherwise clearly contradicted by context. The use of any and all examples, or various language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

METHODS: The synthesis plate may be a 3 mm thick borosilicate glass plate (140×140 mm²) through which 4 sets of vias were drilled along each edge of the plate, with each set being an array of six rows of seventeen vias, in which the vias were 2.25 mm center-to-center down a column of six vias and 4.5 mm center-to-center across a row of seventeen vias. The synthesis plate also included reference marks to enable alignment with the microfluidic patterning plate. The microfluidic patterning plate was a 300 μm thick sheet of tempered glass (180×130 mm²) on top of which 102 microfluidic channels, the corresponding microfluidic inlet and outlet depressions, and reference marks, were recessed into a 100 μm thin layer of SIFEL using standard soft lithography techniques. The 102 channels were each 350 μm wide, 50 μm tail, with 400 μm of spacing between channels.

To begin the synthesis, one entire face of the synthesis plate was continuously functionalized with aminopropyltriethoxysilane (APTS) as described in (Benters et al., 2002) with some modifications. Briefly, the plate was soaked in a 5% Hellmanex III solution overnight. After rinsing with MilliQ water, the plate was soaked in a 5% solution of Citranox for 30 minutes and then rinsed with water. The plate was dried under a stream of filtered nitrogen and exposed to UV-ozone (Jetlab) for 30 minutes. The synthesis surface of the plate was then covered with a 90:5:5 solution of ethanol:water:APTS for 1 hour The plate was rinsed with acetone, then ethanol, and then dried under a stream of nitrogen. The plate was then placed in a vacuum oven at 100° C. overnight. The plate was stored under vacuum until further use.

The microfluidic patterning plate consisting of 102 channels was then sandwiched with the functionalized synthesis plate such that 102 fully sealed channels were formed, each with an inlet and an outlet. Using a multichannel micropipette, 200 mM activated biotin [10% collidine, 190 mM hexafluorophosphate azabenzotriazole tetramethyl uranium (HATU) in DMSO] was added to 18 inlet vias and then delivered across 18 parallel columns by applying pressure to the inlets. After 1 hour at room temperature, the sandwiched plates was disassembled, the microfluidic patterning plate was rotated 90°, and the sandwich was reassembled to create 102 channels across the substrate in an orientation perpendicular to that of the original set of 102 channels. Using a multichannel micropipette, Intercept® (PBS) Blocking Buffer (Licor) was delivered across 16 rows. The solutions were allowed to block the channel surfaces for 30 minutes. The blocking solutions were drained using a combination of a multichannel pipette and a vacuum aspirator. Two different streptavidin-conjugated dyes [IRDye 680RD and IRDye 800CW, diluted 1:10,000 in Intercept® Blocking Buffer (Licor)] were delivered across 16 rows in alternating channels. The solutions were incubated in the channels for 30 minutes. After draining the channels and rinsing the channels with Intercept® Blocking Buffer, the sandwich was disassembled The substrate plate was immediately rinsed with PBST and imaged (Licor Odyssey).

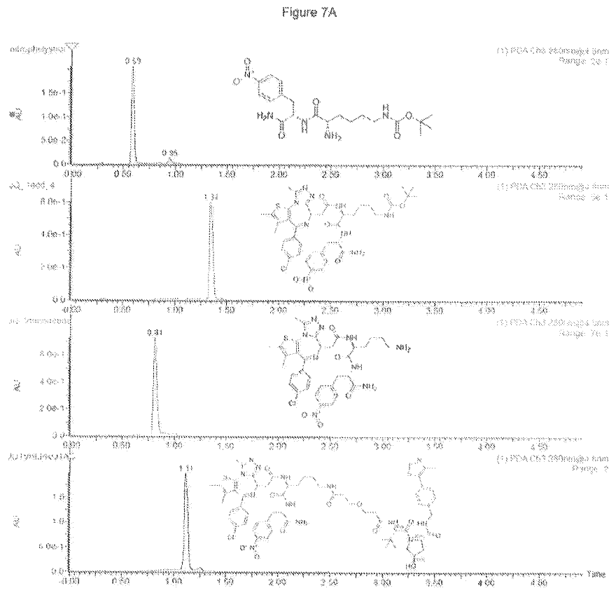

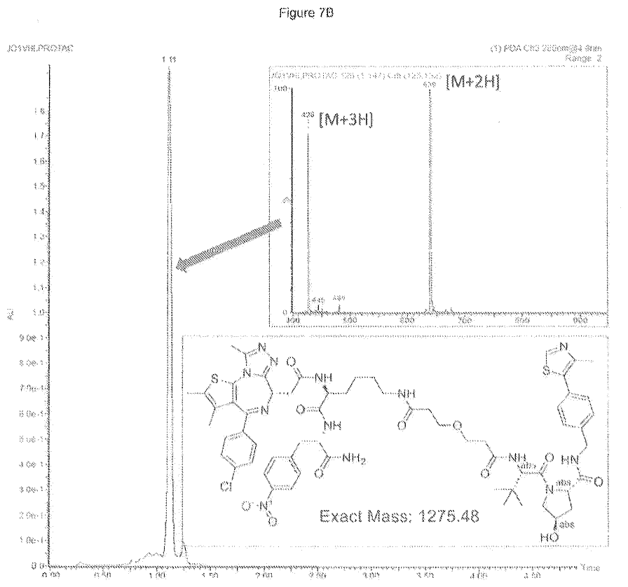

MULTISTEP SYNTHESIS PROCESS TO SYNTHESIZE JQ1-VHL LIGAND CONJUGATE: FIGS. 7A and 7B show LC/MS analysis of a multi-step synthesis using the invention. The substrate surface was first functionalized with dendrimers to increase functional group density (Benters et al., 2002). This was followed by addition of a photolinker, a chromophore to facilitate synthesis monitoring, and a trifunctional core structure (L-lysine) that links the BRD4 ligand JQ1 to a E3 ligase (VHL) ligand. The JQ1 ligand was reacted with a free amine on the core structure. After Boc-deprotection, a VHL ligand was attached to a second attachment site on the core structure to afford the final product. The LC traces (FIG. 7A) show the purity of each crude intermediate, as well as the crude product (FIG. 7B). The MS spectrum of the major peak (FIG. 7B, upper inset) corresponds to the desired product; only the positive ion mode is shown.

METHODS: The synthesis plate was a 3 mm thick borosilicate glass plate (140×140 mm²) through which 4 sets of vias were drilled along each edge of the plate, with each set being an array of six rows of seventeen vias, in which the vias were 2.25 mm center-to-center down a column of six vias and 4.5 mm center-to-center across a row of seventeen vias. The synthesis plate also included reference marks to enable alignment with the microfluidic patterning plate. The microfluidic patterning plate was a 300 μm sheet of tempered glass (180×130 mm²) on top of which 102 microfluidic channels, the corresponding microfluidic inlet and outlet depressions, and reference marks, were recessed into a 100 μm thin layer of SIFEL using standard soft lithography techniques. The 102 channels were each 350 μm wide, 50 μm tall, with 400 μm of spacing between channels.

To begin the synthesis, one entire face of the synthesis plate was continuously functionalized with aminopropyltriethoxysilane (APTS) as described in (Benters et al., 2002) with some modifications. Briefly, the plate was soaked in a 5% Hellmanex III solution overnight. After rinsing with MilliQ water, the plate was soaked in a 5% solution of Citranox for 30 minutes and then rinsed with water. The plate was dried under a stream of filtered nitrogen and exposed to UV-ozone (Jetlab) for 30 minutes. The synthesis surface of the plate was then covered with a 90:5:5 solution of ethanol:water:APTS for 1 hour. The plate was rinsed with acetone, then ethanol, and then dried under a stream of nitrogen. The plate was then placed in a vacuum oven at 100° C. overnight. The plate was stored under vacuum until further use.

Dendrimerization to increase surface yields: The substrate surface was placed in contact with a saturated solution of glutaric anhydride in DMF, sandwiched with an unfunctionalized piece of glass, and left to incubate at room temperature overnight. This step results in the conversion of the surface amine functional groups to carboxyl groups. The substrate was washed with DMF multiple times, once with ethanol, and then blown dry with nitrogen. The microfluidic patterning plate consisting of 102 channels was then sandwiched with the functionalized synthesis plate such that 102 fully sealed channels were formed, each with an inlet and an outlet. The sandwich was further placed between a mechanical clamping system with pressurized air to apply pressure (5 psi) across the substrate. For each LC/MS analysis, the multistep synthesis took place across six channels, each the equivalent of 250 synthesis spots-the entire glass surface area within a single microfluidic channel (0.35×100 mm²). Multiple sets of six channels were used such that different sets of channels could be used to analyze intermediates. To begin the multistep synthesis within the channels, the channels were filled with a 1 M solution of N-hydroxysuccinimide and diisopropylcarbodiimide in DMF. This results in the conversion of the surface carboxyl groups into amine-reactive, activated ester groups. The solution sat for 1 hour, at which point the solutions in each channel were displaced with 10 volumes of DMF, two volumes of methanol, drained, and then filled with a 10% methanolic polyamidoamine (PAMAM) solution (Sigma Aldrich cat. #412449).

Addition of photolinker, chromophore, and trifunctional core structure: Following functionalization of the substrate surface with PAMAM dendrimers, the solutions in each channel were displaced with 5 volumes of methanol followed by 3 volumes of DMF, and then drained. The addition of all reagents involved the use of a multichannel micropipette to deliver the solutions to inlet vias, which were then delivered across parallel channels by applying pressure to the inlets. First, a solution of activated photolinker [100 mM Fmoc-Photo-Linker (Advanced Chemtech, cat. #RT1095), 5% collidine and 95 mM hexafluorophosphate azabenzotriazole tetramethyl uronium (HATU) in DMSO] was added. After 1 hour at room temperature, the reaction solutions were drained, rinsed 3 times with DMF, and the Fmoc group was removed. Here and below, Fmoc removal was accomplished by treating all channels with a 20% solution of 4-methylpiperidine in DMF for 20 minutes. Following rinsing of the channels with 5 volumes of DMF, the channels were drained. Then, a solution of 200 mM activated Fmoc-4-nitro-L-phenylalanine (Chem Impex cat #02447, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained. Then, a solution of 200 mM activated Nα-Fmoc-Nε-Boc-L-lysine (Chem Impex cat #00493, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained.

Addition of the JQ1 and VHL ligand: An activated solution of JQ1 ligand [200 mM (+)-JQ1 carboxylic acid (Tocris, cat. #6588), 10% collidine and 190 mM HATU in DMSO] was added across all channels and allowed to react for one hour. Following reaction, the sandwich was disassembled, and the channels and substrate were rinsed with DMF and then methylene chloride. The substrate surface was treated with 25% TFA in methylene chloride for 30 minutes. Following trifluoroacetic acid (TFA) treatment, the substrate was rinsed with methylene chloride, followed by a 5% collidine solution in DMF, DMF, and then ethanol. The substrate was then dried under a stream of nitrogen, realigned, and reassembled into the microfluidic assembly. An activated solution of VHL ligand [100 mM (VH 032 amide-PEG1-acid, Tocris, cat. #7104), 100 mM N,N′-diisopropylcarbodiimide (DIC), 100 mM hydroxybenzotriazole (HOBt), in DMF] was added and allowed to react for 3 hours at room temperature. Following reaction, the solution was drained from the channels, rinsed five times with DMF and three times with DMSO.

Cleavage and LC/MS analysis: During the synthesis, after the addition of the chromophore and linker; after the addition of the JQ1 ligand; after Boc deprotection (TFA mediated); and after the final coupling of the VHL ligand, samples from a set of six channels were collected for LC/MS analysis. Briefly, a set of six channels was filled with DMSO and all other channels were covered with black film to prevent photocleavage. The microfluidic device was placed under a 365 nm LED lamp (dose 6 mW/cm²) for 15 minutes. The DMSO solutions from the exposed channels were collected into one volume and analyzed by UPLC/MS (Waters Acquity SQD2 LC/MS) in both positive and negative ion mode.

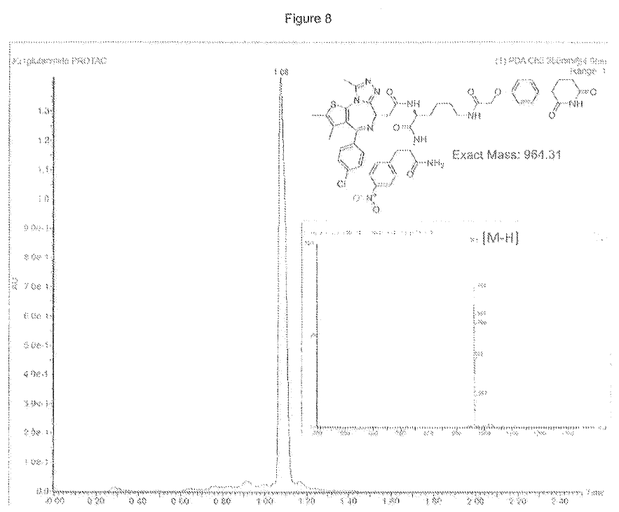

MULTISTEP SYNTHESIS PROCESS TO SYNTHESIZE JQ1-CRBN LIGAND CONJUGATE #1: FIG. 8 shows LC/MS analysis of a multi-step synthesis using the invention. The substrate surface was first functionalized with dendrimers to increase functional group density (Benters et al., 2002). This was followed by addition of a photolinker, a chromophore to facilitate synthesis monitoring, and a trifunctional core structure (L-lysine) that links the BRD4 ligand JQ1 to a E3 ligase (CRBN) ligand, phenyl-glutarimide 4′-oxyacetic acid. The JQ1 ligand was reacted with a free amine on the core structure. After Boc-deprotection, the CRBN ligand was attached to a second attachment site on the core structure to afford the final product. The LC trace shows the purity of the crude product (FIG. 8). The MS spectrum of the major peak (FIG. 8, inset) corresponds to the desired product; only the positive ion mode is shown.

METHODS: The synthesis plate was a 3 mm thick borosilicate glass plate (140×140 mm²) through which 4 sets of vias were drilled along each edge of the plate, with each set being an array of six rows of seventeen vias, in which the vias were 2.25 mm center-to-center down a column of six vias and 4.5 mm center-to-center across a row of seventeen vias. The synthesis plate also included reference marks to enable alignment with the microfluidic patterning plate. The microfluidic patterning plate was a 300 μm sheet of tempered glass (180×130 mm²) on top of which 102 microfluidic channels, the corresponding microfluidic inlet and outlet depressions, and reference marks, were recessed into a 100 μm thin layer of SIFEL using standard soft lithography techniques. The 102 channels were each 350 μm wide, 50 μm tall, with 400 μm of spacing between channels.

To begin the synthesis, one entire face of the synthesis plate was continuously functionalized with aminopropyltriethoxysilane (APTS) as described in (Benters et al., 2002) with some modifications. Briefly, the plate was soaked in a 5% Hellmanex III solution overnight. After rinsing with MilliQ water, the plate was soaked in a 5% solution of Citranox for 30 minutes and then rinsed with water. The plate was dried under a stream of filtered nitrogen and exposed to UV-ozone (Jetlab) for 30 minutes. The synthesis surface of the plate was then covered with a 90:5:5 solution of ethanol:water:APTS for 1 hour. The plate was rinsed with acetone, then ethanol, and then dried under a stream of nitrogen. The plate was then placed in a vacuum oven at 100° C. overnight. The plate was stored under vacuum until further use.

Dendrimerization to increase surface yields: The substrate surface was placed in contact with a saturated solution of glutaric anhydride in DMF, sandwiched with an unfunctionalized piece of glass, and left to incubate at room temperature overnight. This step results in the conversion of the surface amine functional groups to carboxyl groups. The substrate was washed with DMF multiple times, once with ethanol, and then blown dry with nitrogen. The microfluidic patterning plate consisting of 102 channels was then sandwiched with the functionalized synthesis plate such that 102 fully sealed channels were formed, each with an inlet and an outlet. The sandwich was further placed between a mechanical clamping system with pressurized air to apply pressure (5 psi) across the substrate. The multistep synthesis took place across six channels, each the equivalent of 250 synthesis spots-the entire glass surface area within a single microfluidic channel (0.35×100 mm²). To begin the multistep synthesis within the channels, the channels were filled with a 1 M solution of N-hydroxysuccinimide and diisopropylcarbodiimide in DMF. This results in the conversion of the surface carboxyl groups into amine-reactive, activated ester groups. The solution sat for 1 hour, at which point the solutions in each channel were displaced with 10 volumes of DMF, two volumes of methanol, drained, and then filled with a 10% methanolic PAMAM solution (Sigma Aldrich cat. #412449).

Addition of photolinker, chromophore, and trifunctional core structure: Following functionalization of the substrate surface with PAMAM dendrimers, the solutions in each channel were displaced with 5 volumes of methanol followed by 3 volumes of DMF, and then drained. The addition of all reagents involved the use of a multichannel micropipette to deliver the solutions to inlet vias, which were then delivered across parallel channels by applying pressure to the inlets. First, a solution of activated photolinker [100 mM Fmoc-Photo-Linker (Advanced Chemtech, cat. #RT1095), 5% collidine and 95 mM HATU in DMSO] was added. After 1 hour at room temperature, the reaction solutions were drained, rinsed 3 times with DMF, and the Fmoc group was removed. Here and below, Fmoc removal was accomplished by treating all channels with a 20% solution of 4-methylpiperidine in DMF for 20 minutes. Following rinsing of the channels with 5 volumes of DMF, the channels were drained. Then, a solution of 200 mM activated Fmoc-4-nitro-L-phenylalanine (Chem Impex cat #02447, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained. Then, a solution of 200 mM activated Nα-Fmoc-Nε-Boc-L-lysine (Chem Impex cat #00493, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained.

Addition of the JQ1 and CRBN ligand (phenyl-glutarimide 4′-oxyacetic acid): An activated solution of JQ1 ligand [200 mM (+)-JQ1 carboxylic acid (Tocris, cat. #6588), 10% collidine and 190 mM HATU in DMSO] was added across all channels and allowed to react for one hour. Following reaction, the sandwich was disassembled, and the channels and substrate were rinsed with DMF and then methylene chloride. The substrate surface was treated with 25% TFA in methylene chloride for 30 minutes. Following TFA treatment, the substrate was rinsed with methylene chloride, followed by a 5% collidine solution in DMF, DMF, and then ethanol. The substrate was then dried under a stream of nitrogen, realigned, and reassembled into the microfluidic assembly. An activated solution of CRBN ligand [100 mM (phenyl-glutarimide 4′-oxyacetic acid, Tocris, cat. #7670), 100 mM DIC, 100 mM HOBt, in DMF] was added and allowed to react for 3 hours at room temperature. Following reaction, the solution was drained from the channels, rinsed five times with DMF and three times with DMSO.

Cleavage and LC/MS analysis: For LC/MS analysis, a set of six channels was filled with DMSO and all other channels were covered with black film to prevent photocleavage. The microfluidic device was placed under a 365 nm LED lamp (dose 6 mW/cm²) for 15 minutes. The DMSO solutions from the exposed channels were collected into one volume and analyzed by UPLC/MS (Waters Acquity SQD2 LC/MS) in both positive and negative ion mode.

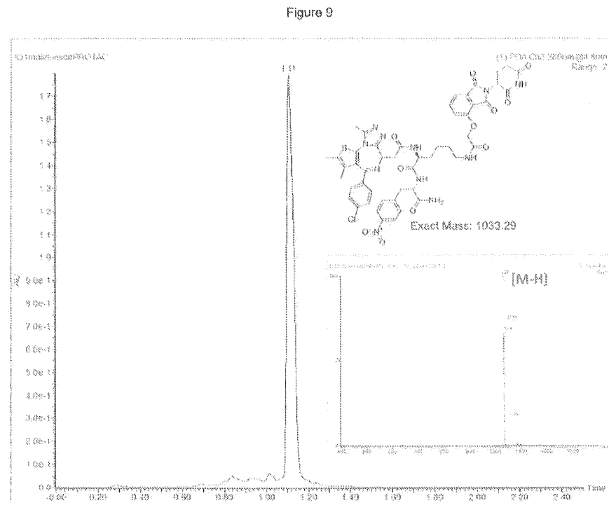

MULTISTEP SYNTHESIS PROCESS TO SYNTHESIZE JQ1-CRBN LIGAND CONJUGATE #2: FIG. 9 shows LC/MS analysis of a multi-step synthesis using the invention. The substrate surface was first functionalized with dendrimers to increase functional group density (Benters et al., 2002). This was followed by addition of a photolinker, a chromophore to facilitate synthesis monitoring, and a trifunctional core structure (L-lysine) that links the BRD4 ligand JQ1 to a E3 ligase (CRBN) ligand, thalidomide-4-hydroxyacetate. The JQ1 ligand was reacted with a free amine on the core structure. After Boc-deprotection, the CRBN ligand was attached to a second attachment site on the core structure to afford the final product. The LC trace shows the purity of the crude product (FIG. 9). The MS spectrum of the major peak (FIG. 9, inset) corresponds to the desired product; only the positive ion mode is shown.

METHODS: The synthesis plate was a 3 mm thick borosilicate glass plate (140×140 mm²) through which 4 sets of vias were drilled along each edge of the plate, with each set being an array of six rows of seventeen vias, in which the vias were 2.25 mm center-to-center down a column of six vias and 4.5 mm center-to-center across a row of seventeen vias. The synthesis plate also included reference marks to enable alignment with the microfluidic patterning plate. The microfluidic patterning plate was a 300 μm sheet of tempered glass (180×130 mm²) on top of which 102 microfluidic channels, the corresponding microfluidic inlet and outlet depressions, and reference marks, were recessed into a 100 μm thin layer of SIFEL using standard soft lithography techniques. The 102 channels were each 350 μm wide, 50 μm tall, with 400 μm of spacing between channels.

To begin the synthesis, one entire face of the synthesis plate was continuously functionalized with aminopropyltriethoxysilane (APTS) as described in (Benters et al., 2002) with some modifications. Briefly, the plate was soaked in a 5% Hellmanex III solution overnight. After rinsing with MilliQ water, the plate was soaked in a 5% solution of Citranox for 30 minutes and then rinsed with water. The plate was dried under a stream of filtered nitrogen and exposed to UV-ozone (Jetlab) for 30 minutes. The synthesis surface of the plate was then covered with a 90:5:5 solution of ethanol:water:APTS for 1 hour. The plate was rinsed with acetone, then ethanol, and then dried under a stream of nitrogen. The plate was then placed in a vacuum oven at 100° C. overnight. The plate was stored under vacuum until further use.

Dendrimerization to increase surface yields: The substrate surface was placed in contact with a saturated solution of glutaric anhydride in DMF, sandwiched with an unfunctionalized piece of glass, and left to incubate at room temperature overnight. This step results in the conversion of the surface amine functional groups to carboxyl groups. The substrate was washed with DMF multiple times, once with ethanol, and then blown dry with nitrogen. The microfluidic patterning plate consisting of 102 channels was then sandwiched with the functionalized synthesis plate such that 102 fully sealed channels were formed, each with an inlet and an outlet. The sandwich was further placed between a mechanical clamping system with pressurized air to apply pressure (5 psi) across the substrate. The multistep synthesis took place across six channels, each the equivalent of 250 synthesis spots-the entire glass surface area within a single microfluidic channel (0.35×100 mm²). To begin the multistep synthesis within the channels, the channels were filled with a 1 M solution of N-hydroxysuccinimide and diisopropylcarbodiimide in DMF. This results in the conversion of the surface carboxyl groups into amine-reactive, activated ester groups. The solution sat for 1 hour, at which point the solutions in each channel were displaced with 10 volumes of DMF, two volumes of methanol, drained, and then filled with a 10% methanolic PAMAM solution (Sigma Aldrich cat. #412449).

Addition of photolinker, chromophore and trifunctional core structure: Following functionalization of the substrate surface with PAMAM dendrimers, the solutions in each channel were displaced with 5 volumes of methanol followed by 3 volumes of DMF, and then drained. The addition of all reagents involved the use of a multichannel micropipette to deliver the solutions to inlet vias, which were then delivered across parallel channels by applying pressure to the inlets. First, a solution of activated photolinker [100 mM Fmoc-Photo-Linker (Advanced Chemtech, cat. #RT1095), 5% collidine and 95 mM HATU in DMSO] was added. After 1 hour at room temperature, the reaction solutions were drained, rinsed 3 times with DMF, and the Fmoc group was removed. Here and below, Fmoc removal was accomplished by treating all channels with a 20% solution of 4-methylpiperidine in DMF for 20 minutes. Following rinsing of the channels with 5 volumes of DMF, the channels were drained. Then, a solution of 200 mM activated Fmoc-4-nitro-L-phenylalanine (Chem Impex cat #02447, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained. Then, a solution of 200 mM activated Nα-Fmoc-Nε-Boc-L-lysine (Chem Impex cat #00493, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained.

Addition of the JQ1 and CRBN ligand (thalidomide 4 hydroxyacetate): An activated solution of JQ1 ligand [200 mM (+)-JQ1 carboxylic acid (Tocris, cat. #6588), 10% collidine and 190 mM HATU in DMSO] was added across all channels and allowed to react for one hour. Following reaction, the sandwich was disassembled, and the channels and substrate were rinsed with DMF and then methylene chloride. The substrate surface was treated with 25% TFA in methylene chloride for 30 minutes. Following TFA treatment, the substrate was rinsed with methylene chloride, followed by a 5% collidine solution in DMF, DMF, and then ethanol. The substrate was then dried under a stream of nitrogen, realigned, and reassembled into the microfluidic assembly. An activated solution of CRBN ligand [100 mM (thalidomide-4-hydroxyacetate (Tocris, cat. #6466), 100 mM DIC, 100 mM HOBt, in DMF] was added and allowed to react for 3 hours at room temperature. Following reaction, the solution was drained from the channels, rinsed five times with DMF and three times with DMSO.

Cleavage and LC/MS analysis: For LC/MS analysis, a set of six channels was filled with DMSO and all other channels were covered with black film to prevent photocleavage. The microfluidic device was placed under a 365 nm LED lamp (dose 6 mW/cm²) for 15 minutes. The DMSO solutions from the exposed channels were collected into one volume and analyzed by UPLC/MS (Waters Acquity SQD2 LC/MS) in both positive and negative ion mode.

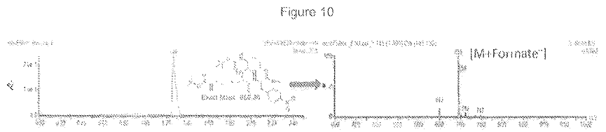

MULTISTEP SYNTHESIS PROCESS TO SYNTHESIZE PRODUCTS 1-12: FIGS. 10-21 each show LC/MS analysis of a multi-step synthesis using the invention. The substrate surface was first functionalized with dendrimers to increase functional group density (Benters et al., 2002). This was followed by addition of a photolinker, a chromophore to facilitate synthesis monitoring, and a trifunctional core structure (L-lysine). Different carboxylic acids were reacted with the free amine on the core structure. In each figure, the LC trace shows the purity of the crude product (left). The MS spectrum (right) of the major peak corresponds to the desired product; only the positive ion mode is shown.

METHODS: The synthesis plate was a 3 mm thick borosilicate glass plate (140×140 mm²) through which 4 sets of vias were drilled along each edge of the plate, with each set being an array of six rows of seventeen vias, in which the vias were 2.25 mm center-to-center down a column of six vias and 4.5 mm center-to-center across a row of seventeen vias. The synthesis plate also included reference marks to enable alignment with the microfluidic patterning plate. The microfluidic patterning plate was a 300 μm sheet of tempered glass (180×130 mm²) on top of which 102 microfluidic channels, the corresponding microfluidic inlet and outlet depressions, and reference marks, were recessed into a 100 μm thin layer of SIFEL using standard soft lithography techniques. The 102 channels were each 350 μm wide, 50 μm tail, with 400 μm of spacing between channels.

To begin the synthesis, one entire face of the synthesis plate was continuously functionalized with aminopropyltriethoxysilane (APTS) as described in (Benters et al., 2002) with some modifications. Briefly, the plate was soaked in a 5% Hellmanex III solution overnight. After rinsing with MilliQ water, the plate was soaked in a 5% solution of Citranox for 30 minutes and then rinsed with water. The plate was dried under a stream of filtered nitrogen and exposed to UV-ozone (Jetlab) for 30 minutes. The synthesis surface of the plate was then covered with a 90:5:5 solution of ethanol:water:APTS for 1 hour. The plate was rinsed with acetone, then ethanol, and then dried under a stream of nitrogen. The plate was then placed in a vacuum oven at 100° C. overnight. The plate was stored under vacuum until further use.

Dendrimerization to increase surface yields: The substrate surface was placed in contact with a saturated solution of glutaric anhydride in DMF, sandwiched with an unfunctionalized piece of glass, and left to incubate at room temperature overnight. This step results in the conversion of the surface amine functional groups to carboxyl groups. The substrate was washed with DMF multiple times, once with ethanol, and then blown dry with nitrogen. The microfluidic patterning plate consisting of 102 channels was then sandwiched with the functionalized synthesis plate such that 102 fully sealed channels were formed, each with an inlet and an outlet. The sandwich was further placed between a mechanical clamping system with pressurized air to apply pressure (5 psi) across the substrate. The multistep synthesis look place across six channels, each the equivalent of 250 synthesis spots-the entire glass surface area within a single microfluidic channel (0.35×100 mm²). To begin the multistep synthesis within the channels, the channels were filled with a 1 M solution of N-hydroxysuccinimide and diisopropylcarbodiimide in DMF. This results in the conversion of the surface carboxyl groups into amine-reactive, activated ester groups. The solution sat for 1 hour, at which point the solutions in each channel were displaced with 10 volumes of DMF, two volumes of methanol, drained, and then filled with a 10% methanolic PAMAM solution (Sigma Aldrich cat. #412449).

Addition of photolinker, chromophore, and trifunctional core structure: Following functionalization of the substrate surface with PAMAM dendrimers, the solutions in each channel were displaced with 5 volumes of methanol followed by 3 volumes of DMF, and then drained. The addition of all reagents involved the use of a multichannel micropipette to deliver the solutions to inlet vias, which were then delivered across parallel channels by applying pressure to the inlets. First, a solution of activated photolinker [100 mM Fmoc-Photo-Linker (Advanced Chemtech, cal. #RT1095), 5% collidine and 95 mM HATU in DMSO] was added. After 1 hour at room temperature, the reaction solutions were drained, rinsed 3 times with DMF, and the Fmoc group was removed. Here and below, Fmoc removal was accomplished by treating all channels with a 20% solution of 4-methylpiperidine in DMF for 20 minutes. Following rinsing of the channels with 5 volumes of DMF, the channels were drained. Then, a solution of 200 mM activated Fmoc-4-nitro-L-phenylalanine (Chem Impex cat #02447, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained. Then, a solution of 200 mM activated Nα-Fmoc-Nε-Boc-L-lysine (Chem Impex cat #00493, 10% collidine and 190 mM HATU in DMSO) was added. After 1 hour at room temperature, the reaction solutions were drained, rinsed 3 times with DMF, and the Fmoc group was removed. Following rinsing of the channels with 5 volumes of DMF, the channels were drained.

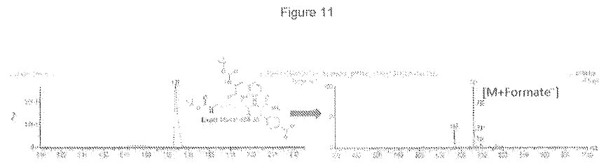

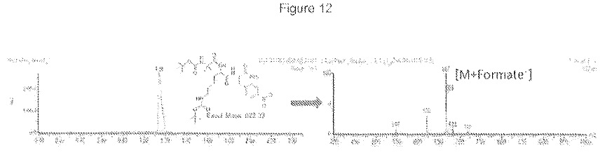

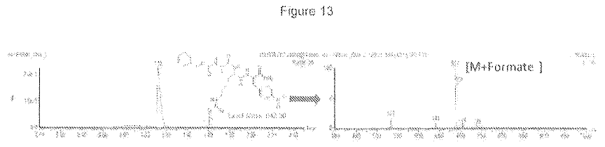

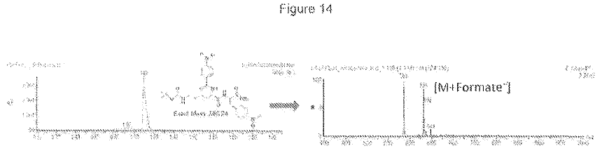

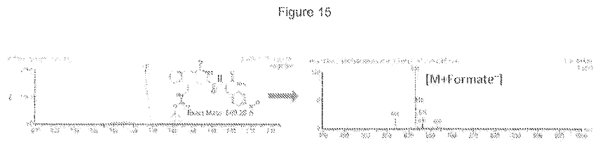

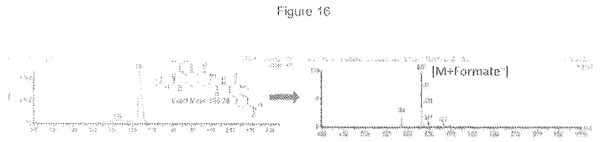

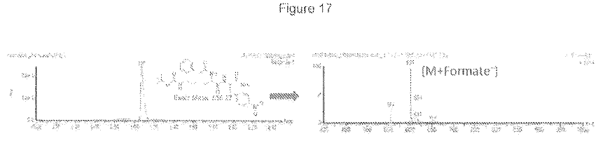

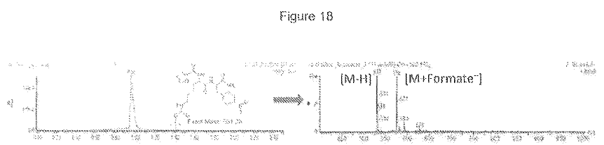

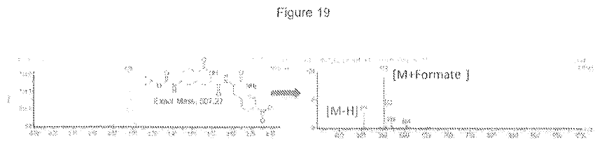

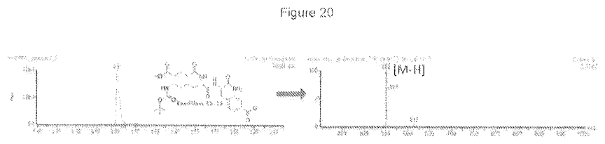

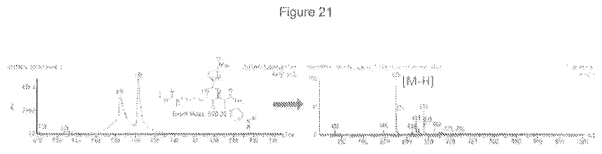

Addition of the carboxylic acid: With the exception of glutaric anhydride, used to synthesize Product 11 (FIG. 20), an activated solution of the carboxylic acid [200 mM, 10% collidine and 190 mM HATU in DMSO] was added across all channels and allowed to react for one hour. Glutaric anhydride (Sigma Aldrich cat. #G3806) was added as a 200 mM solution in DMF. The other carboxylic acids used were: Boc-L-Leucine (Boc-L-leucine hydrate, Chem-Impex cat. #00774) (FIG. 10); Boc-L-phenylalanine, Chem-Impex cat. #00775(FIG. 11); Boc-α-aminoisobutyric acid, Chem-Impex cat. #03779 (FIG. 12); Z-L-alanine, Chem-Impex cat. #02117 (FIG. 13): 4-nitrobenzoic acid, Sigma Aldrich cat. #461091 (FIG. 14); hydrocinnamic acid, Sigma Aldrich cat. #135232 (FIG. 15); 4-methoxyphenylacetic acid, Sigma Aldrich cat. #M19201 (FIG. 16); phenylacetic acid, Sigma Aldrich cat. #P16621 (FIG. 17): 2-furoic acid, Sigma Aldrich cal. #F20505 (FIG. 18); butyric acid, Sigma Aldrich cat. #B103500 (FIG. 19); 5-nitro-2-furoic acid, Sigma Aldrich cat. #155713 (FIG. 21). Following reaction, the channels were rinsed five times with DMF, and three times with DMSO.

Cleavage and LC/MS analysis: For LC/MS analysis, a set of six channels was filled with DMSO and all other channels were covered with black film to prevent photocleavage. The microfluidic device was placed under a 365 nm LED lamp (dose 6 mW/cm²) for 15 minutes. The DMSO solutions from the exposed channels were collected into one volume and analyzed by UPLC/MS (Waters Acquity SQD2 LC/MS) in both positive and negative ion mode.

### INCORPORATION BY REFERENCE

All references, including publications, patent applications, and patents, cited herein are hereby incorporated by reference to the same extent as if each reference were individually and specifically indicated to be incorporated by reference and were set forth in its entirety herein.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

### REFERENCES

Backes, B. J., & Ellman, J. A. (1999). An Alkanesulfonamide “safety-catch” linker for solid-phase synthesis. The Journal of Organic Chemistry, 64(7), 2322-2330. https://doi.org/10.1021/jo981990y
Benters, R., Niemeyer, C. M., Drutschmann, D., Blohm, D., & Wöhrle, D. (2002). DNA microarrays with PAMAM dendritic linker systems. Nucleic Acids Research, 30(2), e10. https://doi.org/10.1093/nar/30.2.e10
Bernard, A., Michel, B., & Delamarche, E. (2001). Micromosaic Immunoassays. Analytical Chemistry, 73(1), 8-12. https://doi.org/10.1021/ac0008845
Bernatowicz, M. S., Daniels, S. B., & Köster. H. (1989). A comparison of acid labile linkage agents for the synthesis of peptide C-terminal amides. Tetrahedron Letters, 30(35), 4645-4648. https://doi.org/10.1016/S0040-4039(01)80764-4
Cras, J. J., Rowe-Taitt, C. A., Nivens. D. A., & Ligler, F. S. (1999). Comparison of chemical cleaning methods of glass in preparation for silanization. Biosensors and Bioelectronics, 14(8), 683-688. https://doi.org/10.1016/S0956-5663(99)00043-3
U.S. Pat. No. 6,508,988B1. Dam, R. M. V., Unger, M. A., & Quake, S. R. (2003). Combinatorial synthesis system. https://patents.google.com/patent/US6508988B1/en?oq=US6508988B1
Delamarche, E., Bernard, A., Schmid, H., Bietsch, A., Michel, B., & Biebuyck, H. (1998). Microfluidic Networks for Chemical Patterning of Substrates: Design and Application to Bioassays. Journal of the American Chemical Society. 120(3), 500-508. https://doi.org/10.1021/ja973071f
Demirci, N., Demirel, M., & Dilsiz, N. (2014). Surface modification of PVC film with allylamine plasma polymers. Advances in Polymer Technology, 33(4). https://doi.org/10.1002/adv.21435
Eggenweiler, H.-M. (1998). Linkers for solid-phase synthesis of small molecules: Coupling and cleavage techniques. Drug Discovery Today, 3(12), 552-560. https://doi.org/10.1016/S1359-6446(98)01265-3
Fair, R. J., Walsh, R. T., & Hupp. C. D. (2021). The expanding reaction toolkit for DNA-encoded libraries. Bioorganic & Medicinal Chemistry Letters, 51, 128339. https://doi.org/10.1016/j.bmcl.2021.128339
Fitzgerald, P. R., & Paegel, B. M. (2021). DNA-Encoded Chemistry: Drug Discovery from a Few Good Reactions. Chemical Reviews, 121(12), 7155-7177. https://doi.org/10.1021/acs.chemrev.0c00789
Fixe, F., Dufva, M., Telleman, P., & Christensen, C. B. V. (2004). Functionalization of poly(methyl methacrylate) (PMMA) as a substrate for DNA microarrays. Nucleic Acids Research, 32(1), e9. https://doi.org/10.1093/nar/gng157
Guillier, F., Orain, D., & Bradley, M. (2000). Linkers and cleavage strategies in solid-phase organic synthesis and combinatorial chemistry. Chemical Reviews, 100(6), 2091-2158. https://doi.org/10.1021/cr980040+
Inagaki, N., Tasaka, S., & Hibi, K. (1992). Surface modification of Kapton film by plasma treatments. Journal of Polymer Science Part A: Polymer Chemistry, 30(7), 1425-1431. https://doi.org/10.1002/pola, 1992.080300722
Kates, S. A., & Albericio, F. (Eds.). (2019). Solid-Phase Synthesis: A Practical Guide. CRC Press.
Kim, S. R. (2000). Surface modification of poly(tetrafluoroethylene) film by chemical etching, plasma, and ion beam treatments. Journal of Applied Polymer Science, 77(9), 1913-1920. https://doi.org/10.1002/1097-4628(20000829)77:9% 3C1913::AID-APP7%3E3.0.CO;2-#
U.S. Pat. No. 6,045,755A. Lebl, M., Pokorny. V., & Krchnak, V. (1997). Apparatus and method for combinatorial chemistry synthesis. https://patents.google.com/patent/US6045755A/en
Malone, M. L., & Paegel, B. M. (2016). What is a “DNA-Compatible” Reaction? ACS Combinatorial Science, 18(4), 182-187. https://doi.org/10.1021/acscombsci.5b00198
U.S. Pat. No. 5,429,807A. Matson, R. S., Coassin, P. J., Rampal, J. B., & Southern, E. M. (1995). Method and apparatus for creating biopolymer arrays on a solid support surface. https://patents.google.com/patent/US5429807A/en
Munief, W.-M., Heib. F., Hempel, F., Lu, X., Schwartz, M., Pachauri, V., Hempelmann. R., Schmitt, M., & Ingebrandt, S. (2018). Silane deposition via gas-phase evaporation and high-resolution surface characterization of the ultrathin siloxane coatings. Langmuir: The ACS Journal of Surfaces and Colloids, 34(35), 10217-10229. https://doi.org/10.1021/acs.langmuir.8b01044
Qin, D., Xia, Y., & Whitesides, G. M. (2010). Soft lithography for micro- and nanoscale patterning. Nature Protocols, 5(3), Article 3. https://doi.org/10.1038/nprot.2009.234
Rink, H. (1987). Solid-phase synthesis of protected peptide fragments using a trialkoxy-diphenyl-methylester resin. Tetrahedron Letters, 28(33), 3787-3790. https://doi.org/10.1016/S0040-4039(00)96384-6
Rowe, C. A., Scruggs, S. B., Feldstein, M. J., Golden, J. P., & Ligler, F. S. (1999). An Array Immunosensor for Simultaneous Detection of Clinical Analytes. Analytical Chemistry, 71(2), 433-439. https://doi.org/10.1021/ac980798t
Satz, A. L., Brunschweiger, A., Flanagan, M. E., Gloger, A., Hansen, N. J. V., Kuai, L., Kunig, V. B. K., Lu, X., Madsen, D., Marcaurelle, L. A., Mulrooney. C., O′Donovan, G., Sakata, S., & Scheuermann, J. (2022). DNA-encoded chemical libraries. Nature Reviews Methods Primers, 2(1), Article 1. https://doi.org/10.1038/s43586-021-00084-5
Su, J., Bringer, M. R., Ismagilov, R. F., & Mrksich, M. (2005). Combining Microfluidic Networks and Peptide Arrays for Multi-Enzyme Assays. Journal of the American Chemical Society, 127(20), 7280-7281. https://doi.org/10.1021/ja051371o
Trimbach, D., Feldman, K., Spencer, N. D., Broer, D. J., & Bastiaansen, C. W. M. (2003). Block copolymer thermoplastic elastomers for microcontact printing. Langmuir, 19(26), 10957-10961. https://doi.org/10.1021/la035214j
U.S. Pat. No. 5,677,195A. Winkier, J. L., Fodor, S. P. A., Buchko, C. J., Ross, D. A., Aldwin. L., & Modlin, D. N. (1997). Combinatorial strategies for polymer synthesis. https://patents.google.com/patent/US5677195A/en
Woo. Y.-H., Mitchell, A. R., & Camarero. J. A. (2007). The Use of Aryl Hydrazide Linkers for the Solid Phase Synthesis of Chemically Modified Peptides. International Journal of Peptide Research and Therapeutics, 13(1), 181-190. https://doi.org/10.1007/s10989-006-9064-x
Wuts, P. G. M., & Greene, T. W. (2007). Greene's Protective Groups in Organic Synthesis. John Wiley & Sons, Inc.
Yraola, F., Ventura, R., Vendrell, M., Colombo, A., Fernández, J.-C., de la Figuera, N., Fernández-Forner, D., Royo, M., Forns, P., & Albericio, F. (2004). A Re-evaluation of the Use of Rink, BAL, and PAL Resins and Linkers. QSAR & Combinatorial Science, 23(2-3), 145-152. https://doi.org/10.1002/qsar.200420013

1.-14. (canceled)

15. A method for combinatorial synthesis of small molecule libraries on a single substrate using a device with a plurality of microfluidic channels, said method using building blocks with reactive groups and comprising the steps of:
a) with the synthesis plate and microfluidic patterning plate sandwiched in a first orientation, flowing a selected known building block through a first selected microfluidic channel and binding covalently said selected building block to the substrate delineated by the walls of the selected channel; and
b) flowing a known building block through a different selected microfluidic channel and binding covalently said building block to the substrate delineated by the walls of the selected channel; and
c) repeating step b) wherein selected building blocks are flowed through other selected microfluidic channels and bound covalently to other delineated regions of the synthesis plate until a diversity of building blocks are arrayed on the single substrate; and
d) flowing wash solutions through selected microfluidic channels; and
e) disassembling the sandwich, rotating the microfluidic patterning plate relative to the synthesis plate, and reassembling the sandwich so as to create a plurality of new fully sealed microfluidic channels in a second orientation in which this second series of channels are non-parallel to the first series of channels used in steps a)-d), creating intersections between the first and second series of channels, with one outlet and one inlet for each channel; and
f) repeating steps a)-d) once such that covalent coupling between building blocks occurs at each intersection that receives a building block through the first orientation of channels and a building block through the second orientation of channels, until a diversity of synthetic small molecule products is arrayed on the single substrate,
wherein the device is a device for the combinatorial synthesis of small molecule libraries on a single substrate, said device comprised of:
A′) a synthesis plate with a plurality of vias (through-holes), in which the vias are patterned in arrays and the total number of vias on the plate will be between 2-100,000; and
B′) a microfluidic patterning plate, with a series of open-faced channels that are aligned with some or all the vias on the synthesis plate such that, when the two plates are sandwiched together, a plurality of fully sealed microfluidic channels are created with one outlet and one inlet for each channel;
C′) wherein the synthesis plate and the microfluidic patterning plate are separate; and
D′) optionally, wherein the synthesis plate has a face that is in contact with the microfluidic patterning plate and is coated with a functionality that enables solid phase synthesis to be executed on the substrate.

16. The method in claim 15, wherein the building blocks may be amine-aryl halides, N-fluorenylmethoxycarbonyl (Fmoc) amino acids, aldehyde-aryl halides, amine-azides, aldehyde-carboxylic acids, carboxylic acid-esters, carboxylic acid-aryl halides, N-tert-butyloxycarbonyl (Boc) amino acids, amine-acids, amine-esters, biotin, carboxylic acid-isothiocyanates, N-Boc amine-aldehydes, aldehyde-sulfonyl halides, mono-N-Boc-protected bisamines, azide-sulfonyl halides, ester-isocyanates, ester-sulfonyl halides, carboxylic acid-alkynes, carboxylic acid-nitro groups, aldehyde-esters, aldehyde-nitro groups, aldehyde-azides, azide-aryl halides, carboxylic acid-azides, aryl halide-alkynes, or aryl halide-aryl halides. The method in claim 15, wherein the building blocks may be amine-aryl halides, N-fluorenylmethoxycarbonyl (Fmoc) amino acids, aldehyde-aryl halides, amine-azides, aldehyde-carboxylic acids, carboxylic acid-esters, carboxylic acid-aryl halides, N-tert-butyloxycarbonyl (Boc) amino acids, amine-acids, amine-esters, biotin, carboxylic acid-isothiocyanates, N-Boc amine-aldehydes, aldehyde-sulfonyl halides, mono-N-Boc-protected bisamines, azide-sulfonyl halides, ester-isocyanates, ester-sulfonyl halides, carboxylic acid-alkynes, carboxylic acid-nitro groups, aldehyde-esters, aldehyde-nitro groups, aldehyde-azides, azide-aryl halides, carboxylic acid-azides, aryl halide-alkynes, or aryl halide-aryl halides.

17. The method as recited in claim 15, wherein each step of flowing selected small molecule building blocks through said microfluidic channels comprises:
a) placing a pipet or syringe in fluid communication with the inlet vias for said microfluidic channels; and
b) injecting said selected building block through said vias so as the building blocks enter the microfluidic channels and flow to the outlet vias.

18. The method in claim 15, wherein the building blocks with reactive groups, some of which are appropriately protected by a protecting group, requiring that in step d), following wash solutions, protecting group removal reagents are flowed through selected microfluidic channels.

19. The method in claim 15, wherein only one building block is flowed through a single selected channel in the first orientation and the second orientation, such that a single small molecule product is synthesized on the single substrate.

20. The method in claim 15, wherein building blocks are flowed through only one selected channel in the first orientation and two selected channels in the second orientation, such that two small molecule products are synthesized on the single substrate.

21. The method in claim 15, wherein building blocks are flowed through two selected channels in the first orientation and only one selected channel in the second orientation, such that two small molecule products are synthesized on the single substrate.

22. The method in claim 15, wherein building blocks are flowed through two selected channels in the first orientation and two selected channels in the second orientation, such that four small molecule products are synthesized on the single substrate.

23. The method in claim 15, wherein the sandwich is disassembled and then reassembled at least twice, oscillating between a first and second orientation, and in each instance, building blocks are flown through the new channels and covalent couplings occur at intersections between the new series of channels and the immediately prior series of channels, until a diversity of synthetic small molecule products resulting from multi-step synthesis is achieved.

24. The method in claim 15, wherein after covalent coupling occur with the device in its second orientation, the sandwich is disassembled, and
a) the sandwich is reassembled so as to create a plurality of new fully sealed microfluidic channels in a third orientation in which this third series of channels are non-parallel to both the first and second series of channels used in steps a)-d) of claim 15 or 18, creating intersections between the first, second, and third series of channels, with one outlet and one inlet for each channel; and
b) repeating steps a)-d) in claims IS or 18 once such that covalent coupling between building blocks occurs at each intersection that receives a building block through the first three orientation of channels, until a diversity of synthetic small molecule products resulting from multi-step synthesis is achieved.

25. The method in claim 24, wherein the sandwich is disassembled and then reassembled at least three times, oscillating between ≥3 orientations, and in each instance, building blocks are flown through the new channels and covalent couplings occur at intersections between the new series of channels and the immediately prior series of channels, until a diversity of synthetic small molecule products resulting from multi-step synthesis is achieved.

26. (canceled)

27. A method for combinatorial synthesis of small molecule libraries on a single substrate using a device with a plurality of microfluidic channels, said method using building blocks with reactive groups and comprising the steps of:
a) with the synthesis plate and microfluidic patterning plate sandwiched in a first orientation, flowing a selected known building block through a first selected microfluidic channel and binding covalently said selected building block to the substrate delineated by the walls of the selected channel; and
b) flowing a known building block through a different selected microfluidic channel and binding covalently said building block to the substrate delineated by the walls of the selected channel; and
c) repeating step b) wherein selected building blocks are flowed through other selected microfluidic channels and bound covalently to other delineated regions of the substrate plate until a diversity of building blocks are arrayed on the single substrate; and
d) flowing wash solutions through selected microfluidic channels; and
e) flowing a selected known building block through each of the selected microfluidic channels used in steps a)-d) such that covalent coupling between building blocks occurs within this first selected series of channels; and
f) flowing wash solutions through selected microfluidic channels; and
g) disassembling the sandwich, rotating the microfluidic patterning plate relative to the synthesis plate, and reassembling the sandwich to create a plurality of new fully sealed microfluidic channels in a second orientation in which this second series of channels are non-parallel to the first series of channels used in steps a)-f), creating intersections between the first and second series of channels, with one outlet and one inlet for each channel; and
h) repeating steps a)-d) once such that covalent coupling between molecules occurs at each intersection that received building blocks occurs at each intersection that received a building block through the first orientation of channels and a building block through the second orientation of channels, until a diversity of synthetic small molecule products is arrayed on the single substrate,
wherein the device is a device for the combinatorial synthesis of small molecule libraries on a single substrate, said device comprised of:
A′) a synthesis plate with a plurality of vias (through-holes), in which the vias are patterned in arrays and the total number of vias on the plate will be between 2-100,000; and
B′) a microfluidic patterning plate with a series of open-faced channels that are aligned with some or all the vias on the synthesis plate such that, when the two plates are sandwiched together, a plurality of fully sealed microfluidic channels are created with one outlet and one inlet for each channel;
C′) wherein the synthesis plate and the microfluidic patterning plate are separate; and
D′) optionally, wherein the synthesis plate has a face that is in contact with the microfluidic patterning plate and is coated with a functionality that enables solid phase synthesis to be executed on the substrate.

28. The method in claim 27, wherein the building blocks may be amine-aryl halides, N-fluorenylmethoxycarbonyl (Fmoc) amino acids, aldehyde-aryl halides, amine-azides, aldehyde-carboxylic acids, carboxylic acid-esters, carboxylic acid-aryl halides, N-tert-butyloxycarbonyl (Boc) amino acids, amine-acids, amine-esters, biotin, biotin, carboxylic acid-isothiocyanates, N-Boc amine-aldehydes, aldehyde-sulfonyl halides, amine-N-Boc amines, azide-sulfonyl halides, ester-isocyanates, ester-sulfonyl halides, carboxylic acid-alkynes, carboxylic acid-nitro groups, aldehyde-esters, aldehyde-nitro groups, aldehyde-azides, azide-aryl halides, carboxylic acid-azides, aryl halide-alkynes, or aryl halide-aryl halides.

29. The method in claim 27, wherein each step of flowing selected small molecule building blocks through said microfluidic channels comprises:
a) placing a pipet or syringe in fluid communication with the inlet vias for said microfluidic channels; and
b) injecting said selected building block through said vias so as the building blocks enter the microfluidic channels and flow to the outlet vias.

30. The method in claim 27, wherein the building blocks with reactive groups, some of which are appropriately protected by a protecting group, requiring that in steps d) and f), following wash solutions, protecting group removal reagents are flowed through selected microfluidic channels.

31. The method in claim 27 that stops after step f) such that a diversity of synthetic small molecule products has been arrayed across the single substrate.

32. The method in claim 27, wherein building blocks are flowed through a single selected channel in the first orientation and the second orientation, such that a single small molecule product is synthesized on the single substrate.

33. The method in claim 27, wherein building blocks are flowed through only one selected channel in the first orientation and two selected channels in the second orientation, such that two small molecule products are synthesized on the single substrate.

34. The method in claim 27, wherein building blocks are flowed through two selected channels in the first orientation and only one selected channel in the second orientation, such that two small molecule products are synthesized on the single substrate.

35. The method in claim 27, wherein building blocks are flowed through two selected channels in the first orientation and two selected channels in the second orientation, such that four small molecule products are synthesized on the single substrate.

36. The method in claim 27, wherein with the microfluidic device in its first orientation, more than two separate sets of building blocks are sequentially flown through the first series of channels, until a diversity of synthetic small molecules resulting from a multi-step synthesis are arrayed on the single substrate.

37. The method in claim 27, wherein following any disassembly and reassembly of the sandwich, two or more separate sets of building blocks are sequentially flown through the newly formed series of channels, until a diversity of synthetic small molecules resulting from a multi-step synthesis are arrayed on the single substrate.

38. The method in claim 27, wherein the sandwich is disassembled and then reassembled at least twice, oscillating between a first and second orientation, and in each instance, building blocks are flown through the new channels and covalent couplings occur at intersections between the new series of channels and the immediately prior series of channels, until a diversity of synthetic small molecule products resulting from multi-step synthesis is achieved.

39. The method in claim 27, wherein after covalent couplings occur with the device in its second orientation, the sandwich is disassembled, and
a) the sandwich is reassembled so as to create a plurality of new fully sealed microfluidic channels in a third orientation in which this third series of channels are non-parallel to both the first and second series of channels used in steps a)-f) of claims 27, creating intersections between the first, second, and third series of channels, with one outlet and one inlet for each channel; and
b) repeating steps a)-d) in claims 27 once such that covalent coupling between building blocks occurs at each intersection that receives a building block through the first three orientation of channels, until a diversity of synthetic small molecule products resulting from multi-step synthesis is achieved.

40. The method in claim 39, wherein following any disassembly and reassembly of the sandwich, two or more separate sets of building blocks are sequentially flown through the newly formed series of channels, until a diversity of synthetic small molecules resulting from a multi-step synthesis are arrayed on the single substrate.

41. The method in claim 39, wherein the sandwich is disassembled and then reassembled at least three times, oscillating between ≥3 orientations, and in each instance, building blocks are flown through the new channels and covalent couplings occur at intersections between the new series of channels and the immediately prior series of channels, until a diversity of synthetic small molecule products resulting from multi-step synthesis is achieved.

42. (canceled)
